(19) United States
(12) Patent Application Publication
(10) Pub. No.: US 2026/0136132 A1
(43) Pub. Date: May 14, 2026

(54) ACOUSTIC PHASE PLUG WITH NON-CIRCULAR EXIT

(71) Applicant: B&C Speakers S.p.A., BAGNO A RIPOLI (Firenze) (IT)

(72) Inventors: Valentina Cardinali, BAGNO A RIPOLI (Firenze) (IT); Andrea Casadei, BAGNO A RIPOLI (Firenze) (IT); Phillip Graham, Tucker, GA (US)

(21) Appl. No.: 19/360,425

(22) Filed: Oct. 16, 2025

Related U.S. Application Data
(63) Continuation of application No. 19/034,144, filed on Jan. 22, 2025.
(60) Provisional application No. 63/709,099, filed on Oct. 18, 2024.
(60) Provisional application No. 63/709,099, filed on Oct. 18, 2024.

(51) Int. Cl. H04R 1/34; H04R 9/06

(52) U.S. Cl. CPC H04R 1/345; H04R 9/06; H04R 2201/34; H04R 2400/13

(57) ABSTRACT

An acoustic phase plug is provided for a compression driver with a dome diaphragm, the phase plug formed of two distinct sub-assemblies, the first defining annular shaped innermost and outermost passageways having acoustic entrances at predefined modal locations, acoustic exits arranged adjacent to one another, vertically displaced from the entrances, and having equivalent path lengths from the respective entrances to exits, the second sub assembly having an annular shaped acoustic entrance at the termination of the innermost and outermost passageways, with a second passageway extending from the acoustic entrance to a non-circular acoustic exit.

### CROSS REFERENCE TO RELATED APPLICATIONS

This U.S. non-provisional patent application is a continuation of U.S. patent application Ser. No. 19/034,144 filed on Jan. 22, 2025, which claimed the benefit of and priority to U.S. Provisional Patent Application No. 63/709,099, filed Oct. 18, 2024, the entire contents of all of said applications are incorporated herein by reference.

### TECHNICAL FIELD

The present invention relates to the field of acoustic engineering, with a particular focus on the design and development of phase plugs for high-frequency compression drivers. More specifically, the invention addresses the challenges associated with achieving precise sound directivity and optimal audio output in loudspeaker arrays while providing loudspeakers of reduced size and simple construction.

### BACKGROUND

In the field of loudspeaker design, particularly for high-frequency applications, achieving precise sound directivity is a critical objective. Arrays of loudspeakers, typically vertically oriented, are commonly employed to ensure that sound is directed in a controlled and focused manner, thereby enhancing the auditory experience in various settings, such as concert halls, auditoriums, and outdoor venues. The ability to control sound directivity is essential for delivering clear and consistent audio to the intended audience while minimizing sound dispersion to unwanted areas.

FIG. 1 shows an exemplary array 10 consisting of a plurality vertically aligned loudspeakers 12 affixed one on top of another to form the array. FIGS. 2A-2B show front and sectional views of one of the loudspeakers 12. Such a loudspeaker 12 typically includes low frequency transducers 14 and high frequency transducers 16. The high frequency transducers 16 are traditionally compression drivers provided with a circular acoustic exit 18. FIG. 3A shows a high frequency compression driver 16 having a magnetic motor 20 which drives a concave diaphragm 22 in a compression chamber 23 to generate acoustic waves that propagate through a phase plug 24 to the circular exit 18. FIG. 3B shows a similar high frequency compression driver 16 having a convex diaphragm 22 with the circular acoustic exit 18. However, these circular exits 18 are not naturally suited to achieve the desired sound directivity in loudspeaker arrays. The circular shape of the exit in a vertical or horizontal array can lead to sound dispersion that is less focused and more prone to interference, thereby compromising the overall sound quality and directivity.

To address this design mismatch, an additional component is traditionally introduced to convert the circular exit of the high-frequency driver into a linear exit. This component, often referred to as a waveguide or adapter, shown at reference numeral 26 in FIG. 2A, is designed to reshape the sound wave as it propagates through the circular acoustic exit 18 of the compression driver 16, transforming it from a circular to a linear form at a linear acoustic exit 28. While this solution can be effective in facilitating the necessary directivity, it comes with its own set of challenges. The introduction of this additional component 26 increases the overall size and complexity of the loudspeaker system. This increase in size can be particularly disadvantageous in applications where space is limited or where a compact design is desired, such as in portable sound systems or installations with aesthetic constraints.

The added component 26 can introduce potential acoustic inefficiencies, such as reflection, diffraction, and unwanted modal behavior which can degrade the sound quality. These inefficiencies can result in a less accurate sound reproduction, affecting the listener's experience. Particularly, vibration of curved circular diaphragms 22 (i.e., convex or concave) within a compression chamber 23 can excite compression chamber acoustical modes, thus degrading quality of the sound output. This problem is not addressed by component 26, but by the phase plug within the compression driver. Because component 26 comes after the phase plug assembly, it cannot address acoustically undesirable effects in the compression chamber. The length of component 26 disadvantageously enlarges the overall loudspeaker and/or results in unwanted acoustic losses, and attempting to address any acoustic issues of the compression driver via component 26 still often yields unsatisfactory results. Thus, the compression chamber acoustical issues persist and the quality of the output is less than optimal.

Consequently, there is a pressing need for innovative solutions that can provide the required linear acoustic exit without the drawbacks of added bulk and complexity, and which also addresses unwanted modal behavior. Such solutions would ideally integrate the transformation from circular to linear exit within the high-frequency driver itself, thereby maintaining a compact design while ensuring optimal sound directivity and quality. This need for innovation drives ongoing research and development in the field, as designers seek to overcome the limitations of current systems and deliver superior audio performance in a reduced size loudspeaker arrangement.

### BRIEF SUMMARY

A phase plug assembly is provided for an electrodynamic compression driver, including a first and a second section. The first section includes: a compression chamber formed by a convex or concave oscillating diaphragm and a boundary face of the phase plug assembly arranged adjacent to the diaphragm; a central axis of rotation, defined within an interior of the phase plug assembly which extends from the boundary face of the compression chamber to a termination of the phase plug assembly; at least two passageways, each of which extends about the central axis and traverses through the first section of the phase plug assembly from the boundary face to the termination of the first section; said at least two passageways comprising an innermost passageway and an outermost passageway disposed radially outward of the innermost passageway; where the termination of the first section of the phase plug is displaced vertically from the boundary face of the first section of the phase plug along the central axis; where each of the passageways expands in cross sectional area between a respective entrance at the boundary face of the first section of the phase plug assembly and the termination of the first section; where a length of the outermost passageway from the entrance at the boundary face to the termination of the first section is equivalent to a corresponding length of the inner passageways; where said length is defined by a pathlength along a centerline of the passageway; where at the termination the first section of the phase plug, the passageways are arranged in a plane normal to the central axis and vertically displaced from the compression chamber; where a shape of the passageways, as defined at the termination of the first section of the phase plug assembly, and as viewed along the central axis, form circular annuli, oval annuli, or obround annuli.

The second section of the phase plug assembly includes: an acoustic entrance disposed at the termination of the first section of the phase plug; an acoustic exit, vertically displaced from the acoustic entrance along the central axis and having an exit shape that is rectangular, filleted rectangular, obround, or oval; at least one second section passageway that traverses through an interior of the second section of the phase plug assembly from the acoustic entrance to the acoustic exit; where the acoustic exit is shaped to radiate acoustic energy from the phase plug assembly into free space, a horn, a waveguide, or other acoustic impedance matching device; where a total surface area of the second section passageway expands between the acoustic entrance and the acoustic exit; where a length along the second section passageway determines a propagation delay through the second section of the phase plug to control an acoustic phase of a wavefront radiating from the acoustic exit.

### BRIEF DESCRIPTION OF THE DRAWINGS

For a more complete understanding of this disclosure, reference is now made to the following brief description, taken in connection with the accompanying drawings and detailed description, wherein like reference numerals represent like parts, in which:

FIG. 1 shows an exemplary array of loudspeakers, vertically displaced;

FIGS. 2A-B show cross-section and front views of a loudspeaker of the array of FIG. 1;

FIGS. 3A-B show examples of acoustic compression drivers;

FIG. 4 is a perspective view of a loudspeaker assembly in one exemplary embodiment;

FIG. 5 is a cross-section view of the assembly of FIG. 4 taken along axis 2-2;

FIG. 6 is an enlarged partial view of the cross-section of FIG. 5;

FIG. 7 is a cross-section view of the assembly of FIG. 4 taken along axis 1-1;

FIGS. 8-9 show exploded views of the loudspeaker assembly of FIG. 4;

FIGS. 10-12 show various views of a phase plug assembly in one exemplary embodiment;

FIGS. 13-14 show exploded views thereof;

FIGS. 15-17 are various views of an outer annular part of a first section of the phase plug assembly;

FIGS. 18-19 are various views of an inner annular part of a first section of the phase plug assembly;

FIGS. 20-21 show various views of a second section of the phase plug assembly;

FIGS. 22-23 are views of an outer housing of the second section of the phase plug assembly;

FIGS. 24-26 provide various views of an inner wedge element of the second section of the phase plug assembly;

FIGS. 27-29 illustrate a parameterization pertaining to the size of the inner wedge element of the second section of the phase plug assembly;

FIGS. 30-31 show further exemplary embodiments of the phase plug assembly second section having obround and oval acoustic exits;

FIGS. 32-34 show a compression driver with a phase plug assembly having an inner wedge element in another embodiment of the invention including a “bent” structure;

FIGS. 35-36 show a compression driver with a phase plug assembly having a non-bent multicellular inner wedge element;

FIGS. 37-42 show various views of a multicellular inner wedge element for a phase plug assembly;

FIGS. 43-45 show various views of a loudspeaker assembly with a phase plug having a multicellular inner wedge element;

FIGS. 46-47 show various views of a loudspeaker assembly with a phase plug having a non-multicellular inner wedge element;

FIGS. 48-51 show alternative embodiments of an asymmetric multicellular inner wedge element; and

FIGS. 52-53 show an alternative embodiment of the multicellular inner wedge element having asymmetric vanes.

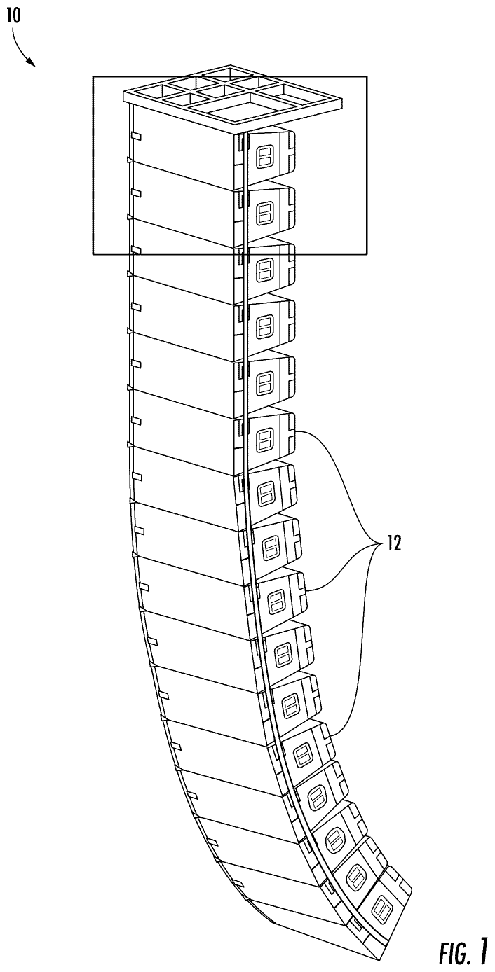

### DETAILED DESCRIPTION

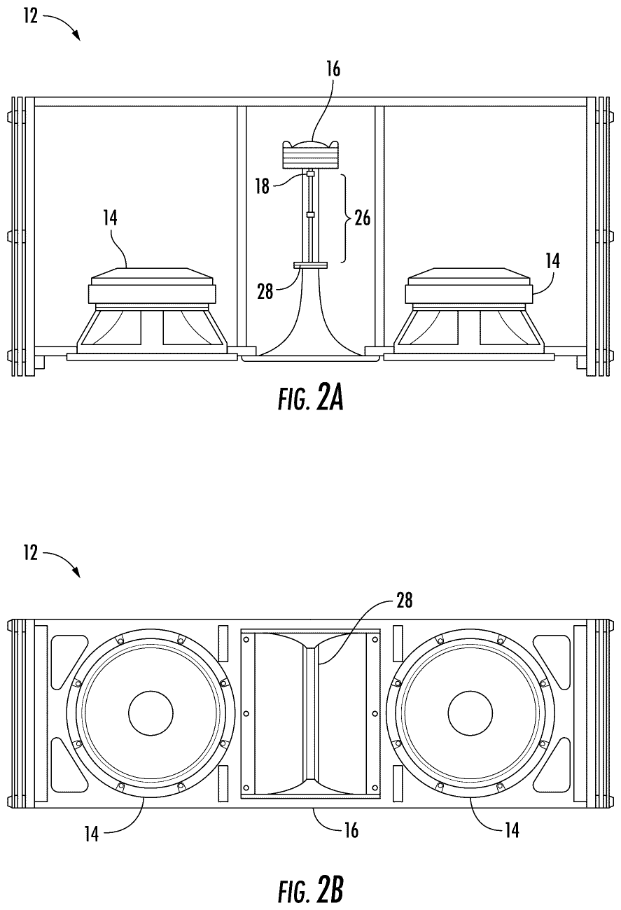

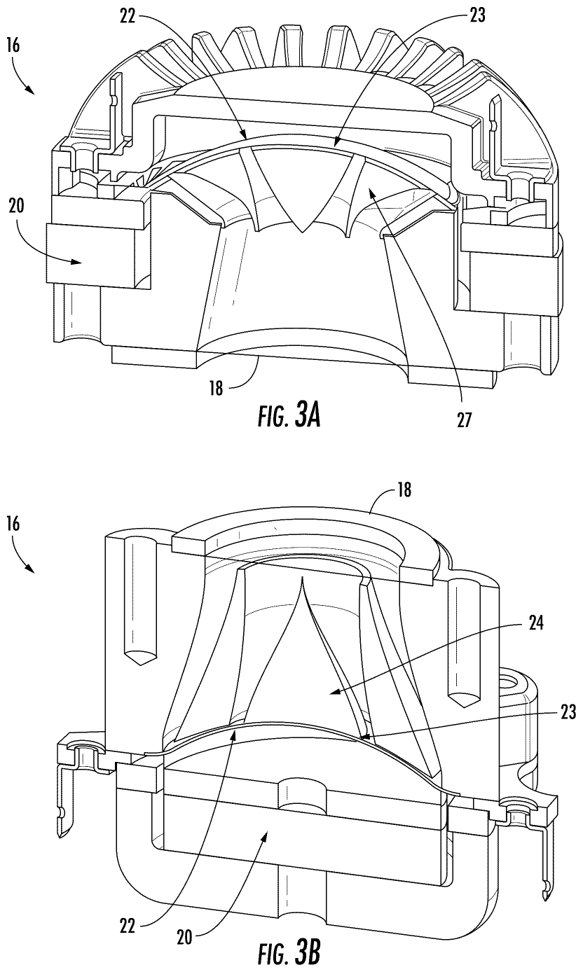

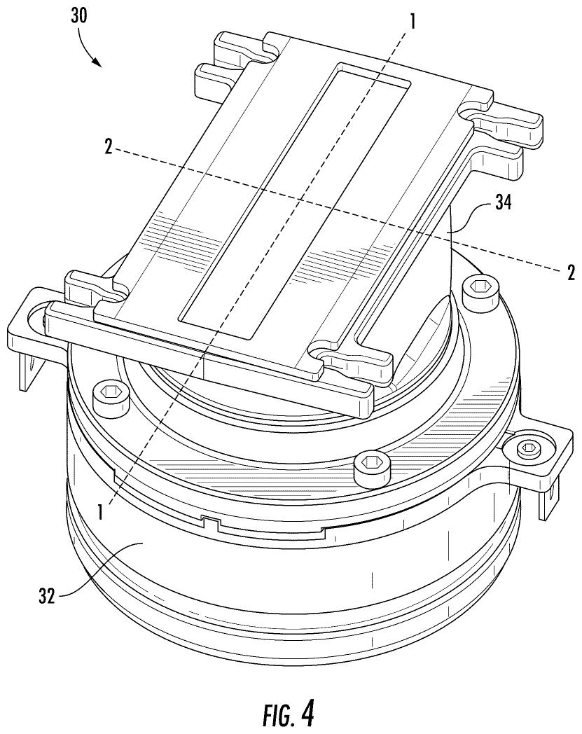

FIG. 4 shows a loudspeaker assembly 30 comprising a dome electromagnetic compression driver 32 and a phase plug assembly 34 that provides a non-circular acoustic exit without requiring an adapter or extra component as seen in existing technologies (see element 26 in FIG. 2A), and which addresses undesirable compression chamber modal behavior to provide enhanced acoustic performance.

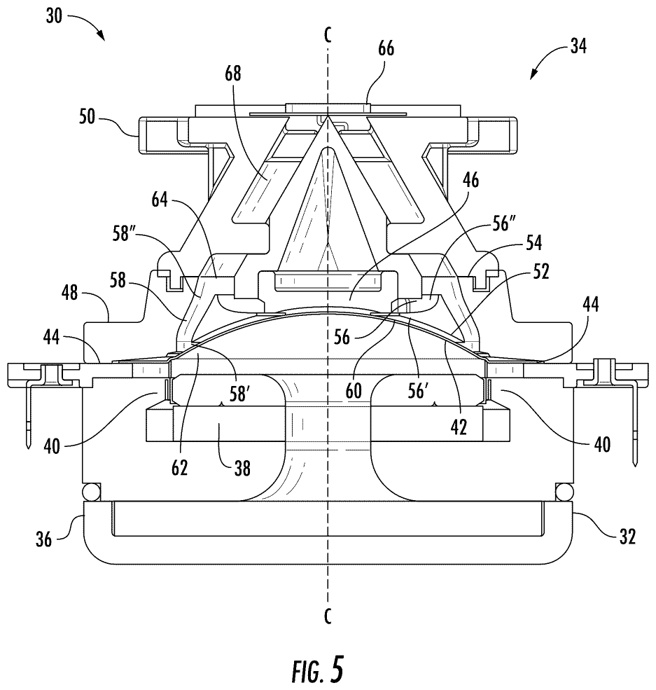

Referring to the cross-sectional views of FIGS. 5-7, the loudspeaker assembly 30 includes a housing 36 that contains a magnetic motor assembly 38 which is operable to drive a voice coil 40 connected to a dome diaphragm 42. In the illustrated example, the dome diaphragm 42 is a convex diaphragm having a generally circular shape when viewed along a central axis of rotation C-C of the loudspeaker assembly 30. The diaphragm 42 is clamped at its perimeter to the housing 36 by an element 44. When the voice coil 40 is driven by the motor 38, the diaphragm 42 vibrates within a compression chamber 46 delimited between the diaphragm 42 and by the phase plug 34.

The phase plug 34 is formed of a first section 48 and a second section 50 that are each separate sub-assemblies which are affixed together to form the phase plug 34. The first section 48 of the phase plug 34 includes a boundary face 52 located adjacent to the diaphragm 42 when the phase plug 34 is disposed upon the compression driver 32. The compression chamber 46 is formed on one side by the diaphragm 42 and on an opposite side by the boundary face 52 of the first section 48 of the phase plug 34. The central axis of rotation C-C extends from the boundary face 52 to a termination 54 of the first section 48 of the phase plug assembly 34. The termination 54 is disposed on a side of the first section 48 opposite from the boundary face 52.

At least two passageways extend through the first section 48 of the phase plug 34. The illustrated example includes an innermost passageway 56 and an outermost passageway 58, each of which extends about the central axis C-C and traverses through the first section 48 of the phase plug assembly 34 from the boundary face 52 to the termination 54 of the first section 48. The innermost and outermost passageways 56, 58 extend annularly around the central axis of rotation C-C, and the outermost passageway 58 is disposed radially outward of the innermost passageway 54.

The termination 54 of the first section 48 of the phase plug 34 is displaced vertically from the boundary face 52 a predetermined distance along the central axis C-C. The innermost and outermost passageways 56, 58 extend generally in this vertical direction through the first section 48 of the phase plug 34.

Each of the passageways 56, 58 expand in cross sectional area between a respective entrance at the boundary face 52 of the first section 48 of the phase plug assembly 34 and the termination 54 of the first section 34. Particularly, the innermost passageway 56 includes an entrance 56′ at the compression chamber 46 and an exit 56″ at the termination 54 of the first section 48 of the phase plug assembly 34. A cross-sectional area of the innermost passageway 56 at the entrance 56′ is less than a cross-sectional area of the innermost passageway 56 at the exit 56″. In one non-limiting example, the cross-sectional area at the entrance 56′ of the innermost passageway may be about 122 mm², while the cross-sectional area at the exit 56″ may be about 143 mm².

Similarly, the outermost passageway 58 includes an entrance 58′ at the compression chamber 46 and an exit 58″ at the termination 54 of the first section 48 of the phase plug assembly 34. A cross-sectional area of the outermost passageway 58 at the entrance 58′ is less than a cross-sectional area of the outermost passageway 58 at the exit 58. In another non-limiting example, the cross-sectional area at the entrance 58′ of the outermost passageway 58 may be about 258 mm², while the cross-sectional area at the exit 58″ may be about 304 mm².

When viewed along the central axis of rotation C-C, the innermost and outermost passageways 56, 58 at the exits 56″ and 58″, may be shaped as a circular annuli, oval annuli, or obround annuli. The shape of the innermost and outermost passageways 56, 58 at the entrances 56′ and 58′, when viewed along the central axis C-C, may be shaped in correspondence with the exit shape or differently.

The lengths of the innermost and outermost passageways 56, 58 are preferably generally equivalent. That is, a length of the outermost passageway 58 from the entrance 58′ at the boundary face 52 to the exit 58″ at the termination 54 of the first section 48 of the phase plug 34 is generally the same as a corresponding length of the innermost passageway 56 from its entrance 56′ to its exit 56″. In one example, this equivalent length is about 9.5 mm. The length of the innermost and outermost passageways 56, 58 is defined as a pathlength along a centerline of the respective passageway.

The oscillation of dome diaphragm 42 within the compression chamber 46 excites at least one acoustic mode within the chamber, e.g. at a location 60 and at a location 62. For most embodiments, the entrance 56′ of the innermost passageway 56 is aligned with and disposed at the chamber's acoustic mode node 60. Similarly, the entrance 58′ of the outermost passageway 58″ is aligned with and disposed at the location of the chamber's acoustic mode node 62. This placement of the entrances 56′, 58′ of the passageways 56, 58 reduces modal activation in the compression chamber. The two passageway locations correspond to the fact that the second order acoustic mode of the compression chamber has two physical node locations.

By contrast, if the compression chamber is larger in diameter, oscillation of the dome diaphragm 42 may produce more than two compression chamber acoustic modal node locations. In this case, the first section 48 of the phase plug 34 may be modified to include additional passageways aligned with the additional compression chamber modal nodes, in the same manner as the case of an inner and an outer passageway in the paragraph above.

Finally, in the specific case of a very small compression chamber dimension, the second order compression chamber mode will be outside the frequency reproduction band of interest, and the at least two passageways are instead balanced strategically to cancel the activation of the first order chamber mode, which has a single node in a single physical location.

The exit 56″ of the innermost passageway 56 and the exit 58″ of the outermost passageway 58 are aligned in a virtual plane V-V which extends perpendicular to the central axis C-C. At the virtual plane V-V, the cross-section of the phase plug 34 transitions from the described dual axis-symmetric passageways 56, 58 to a progressively rectangular single slot exit passageway, as further described below. The path length and expansion rate of the innermost and outermost passageways 56, 58 must be similar from the compression chamber 46 to the location of the virtual plane V-V which is coincident, or nearly coincident, with the termination 54 of the first section of the phase plug 48.

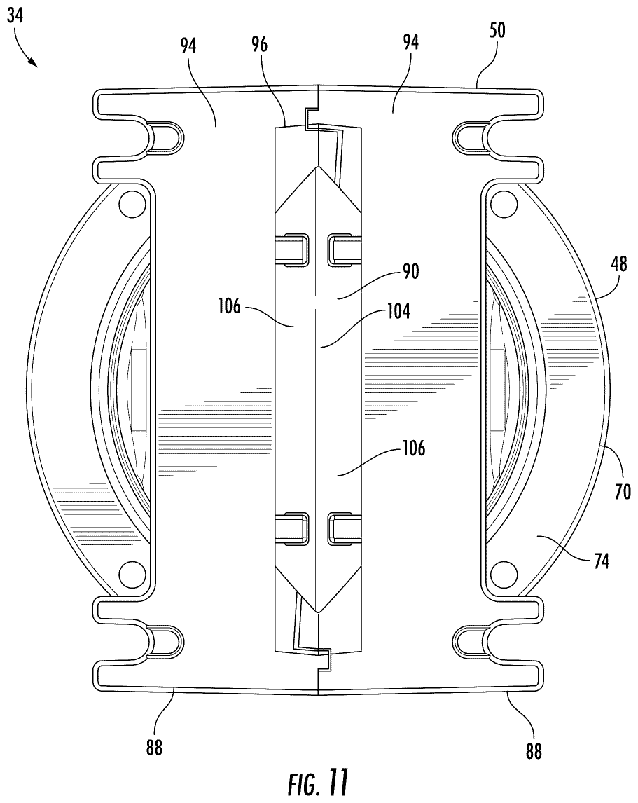

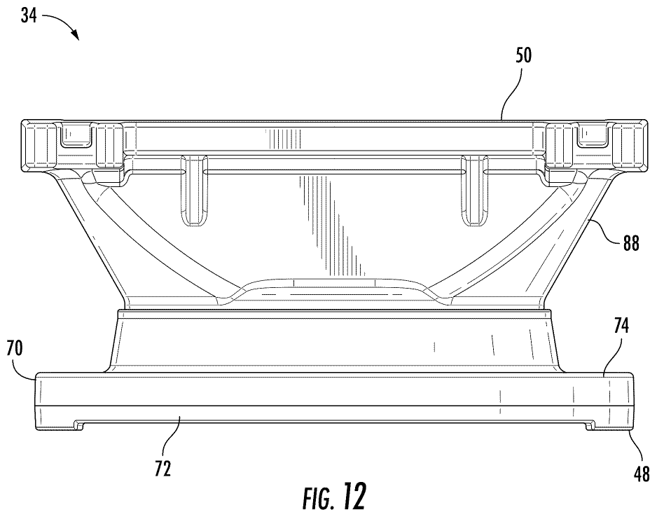

The second section 50 of the phase plug assembly 34 includes an acoustic entrance 64 disposed on a side of the second section 50 adjacent to the termination 54 of the first section 48 of the phase plug 34. As illustrated, the acoustic entrance 64 is aligned with the virtual plane V-V. The second section 50 correspondingly includes an acoustic exit 66 disposed oppositely from the acoustic entrance 64, vertically displaced from the acoustic entrance 64 along the central axis C-C. The acoustic exit 66 delimits an exit shape that is rectangular, filleted rectangular, obround, or oval, and is shaped to radiate acoustic energy from the loudspeaker assembly 30 into free space, a horn, a waveguide, or other acoustic impedance matching device. See, FIGS. 11, 30, 31, etc.

The second section 50 of the phase plug assembly 34 further includes a second section passageway 68 that traverses through an interior of the second section 50 from the acoustic entrance 64 to the acoustic exit 66. The second section passageway 68 includes a surface area that expands between the acoustic entrance 64 and the acoustic exit 66. The acoustic entrance 64 of the second section 50 is sized, shaped, and aligned so as to correspond to the exits 56″, 58″ of the innermost and outermost passageways 56, 58. That is, at the virtual plane V-V, the innermost and outermost passageways 56, 58 merge together and join the second section passageway 68. Acoustic sound waves arriving at the virtual plane V-V through the innermost and outermost passageways 56, 58 propagate through the second section passageway 68 to the non-circular acoustic exit 66. A length along the second section passageway 68 is designed to determine a propagation delay through the second section 50 of the phase plug 34 to control an acoustic phase of a wavefront radiating from the acoustic exit. The length along the second section passageway, measured along a centerline thereof, may be about 26.5 mm.

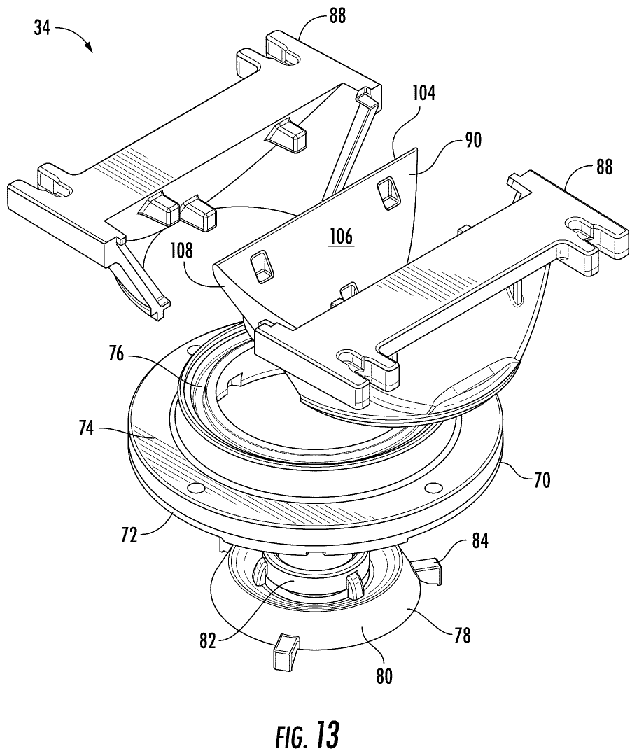

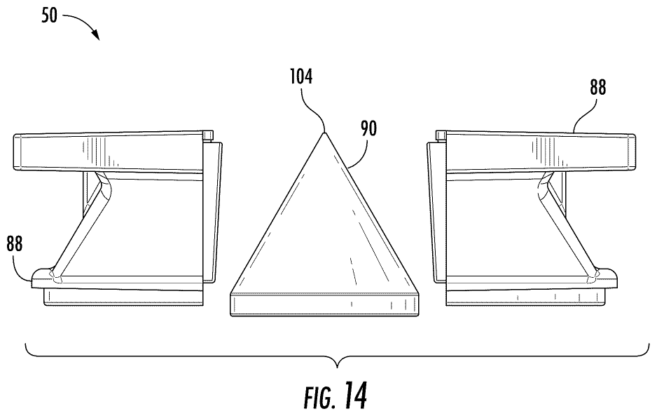

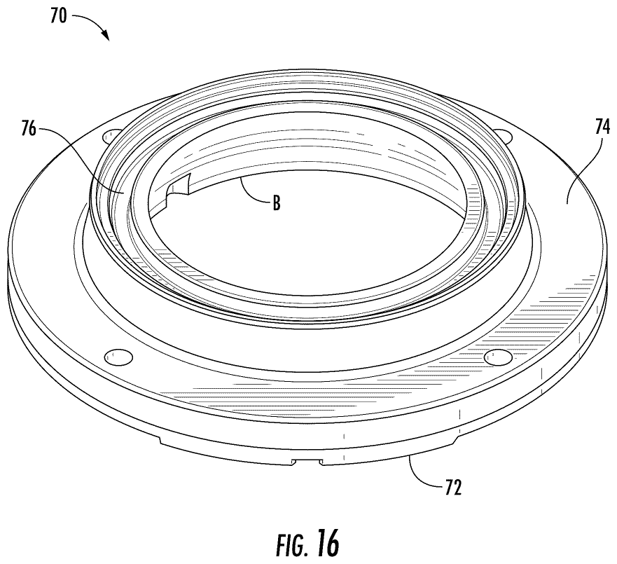

The first section 48 of the phase plug 34 comprises a first mechanical sub-assembly that defines the innermost and outermost passageways 56, 58 of the first section 48 and is mechanically discontinuous and separable from the second section 50 of the phase plug assembly 34. For example, with reference to FIGS. 13-17, the first section 48 of the phase plug 34 may comprise an outer annular part 70 having a first side 72 disposed adjacent to the diaphragm 42 and an opposite second side 74 arranged proximate to the second section 50 of the phase plug 34. The outer annular part 70 includes a mating groove 76 on the second side 74 to facilitate affixation with the second section 50 of the phase plug assembly. The first side 72 of the annular part 70 is configured to receive an inner annular part 78 to thus form the first section 48 of the phase plug 34.

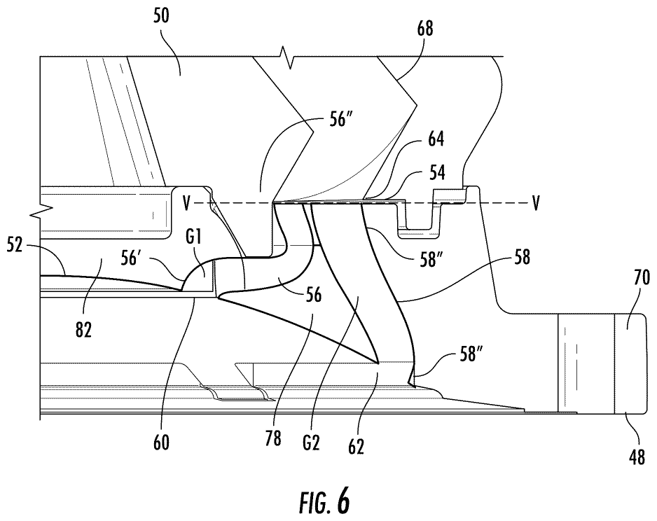

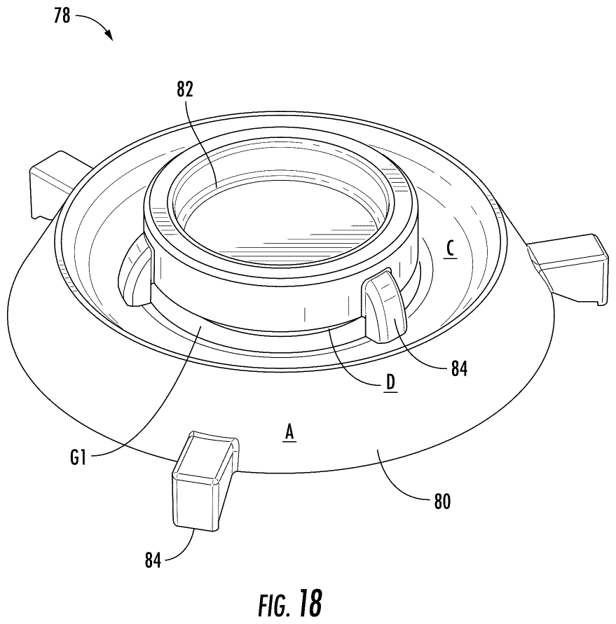

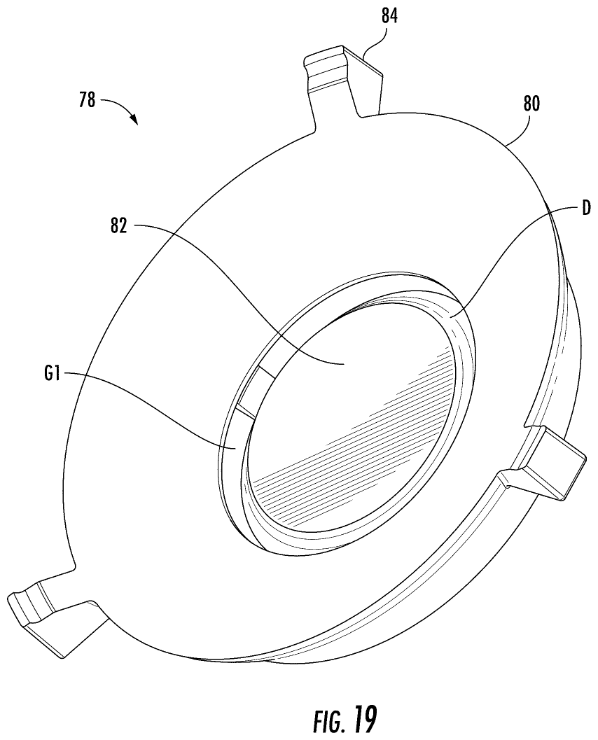

Referring now particularly to FIGS. 13 and 18-19, the inner annular part 78 comprises a ring portion 80 and a circular portion 82, each having a plurality of mounting feet 84. The ring portion 80 extends around an outer circumference of the circular portion 82 which sits atop the ring portion 80, the mounting feet 84 extending from the circular portion 82 to the ring portion 80 in order to mount the former upon the latter. These mounting feet 84 delimit a gap G1 between the ring portion 80 and the circle portion 82 which forms part of the innermost passageway 56. The mounting feet 84 on the ring portion 80 are received within mounting apertures 86 formed into the first side 72 of the outer annular part 70. With the mounting feet 84 of the ring portion 80 seated within the mounting apertures 86 of the outer annular part 70, a gap G2 is delimited which forms a part of the outermost passageway 58. (See, particularly, FIG. 6.)

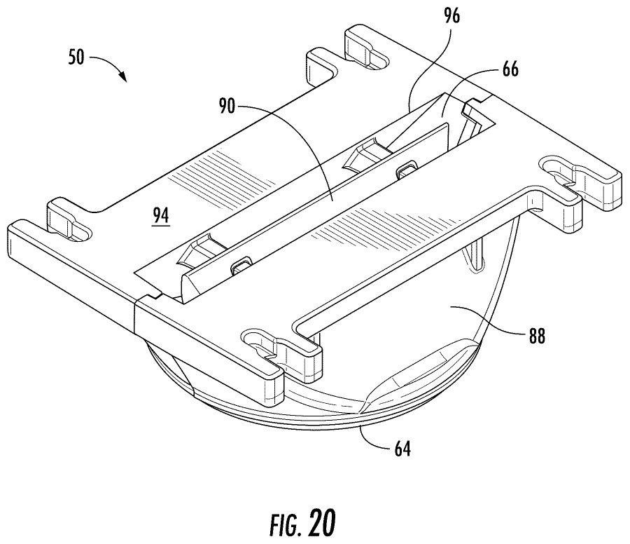

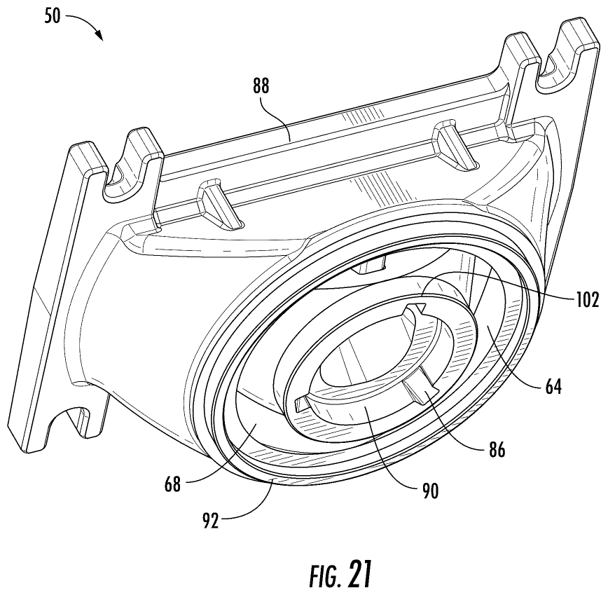

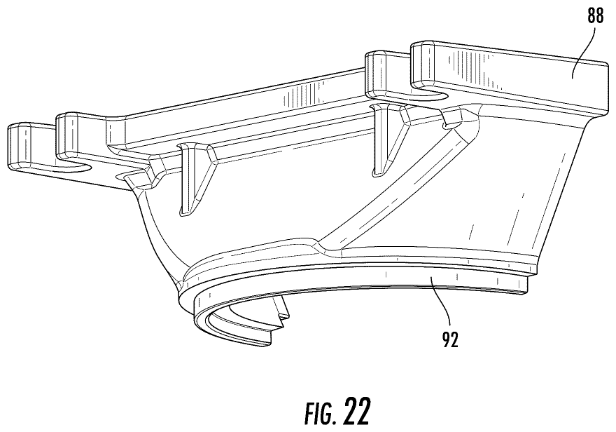

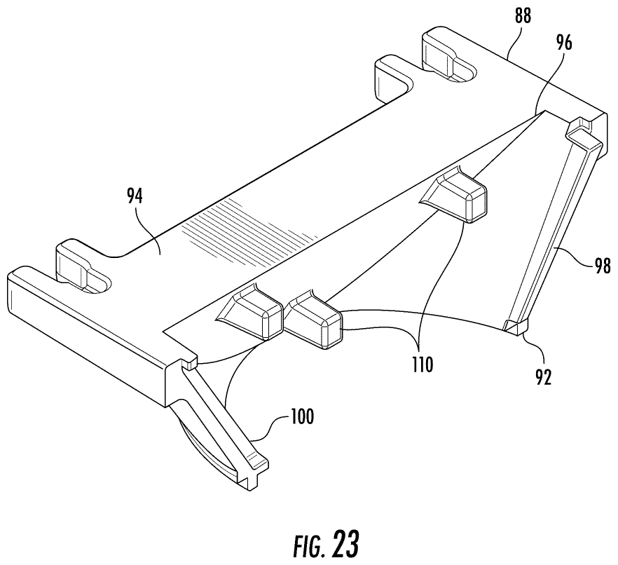

The second section 50 of the phase plug assembly 34 comprises a second mechanical sub-assembly that defines the acoustic entrance 64 and acoustic exit 66 of the second section 50 and is mechanically discontinuous and separable from the first section 48 of the phase plug assembly 34. For example, as shown at FIGS. 20-21, the second section 50 comprises an outer housing 88 and an inner wedge element 90. On one side, at the acoustic entrance 64, the outer housing 88 includes a circular flange 92 configured to be received within the matting groove 76 of the outer annular part 70 of the first section 48 of the phase plug 34. On an opposite side, the outer housing 88 includes the non-circular acoustic exit 66. In the illustrated example, the outer housing 88 includes a planar surface 94 with a non-circular cutout 96 that defines the acoustic exit 66. The outer housing 88 may be a single monolithic part or, as shown in FIGS. 22-23, it may be composed of two identical halves which are affixed together to form the housing 88. In one embodiment, each half includes a mounting tab 98 and a mounting recess 100. When the halves are brought together, the mounting tabs 98 are received and retained within the opposing mounting recesses 100 in order to form the outer housing 88. Each half of the housing 88 may further include prongs 110 for facilitating mating with the inner wedge element 90.

The inner wedge element 90 comprises a receiving end 102 on one side and a linear peak 104 on an opposing side. In the embodiment illustrated in the drawings, the receiving end 102 of the inner wedge element is circular when viewed along the central axis C-C. However, in other embodiments, the receiving end 102 may have a different shape, for example, oval or obround. The inner wedge element 90 further includes two opposing major surfaces 106 and two opposing minor surfaces 108, all of which extend from the circular receiving end 102 to the linear peak 104. The major surfaces 106 extend along the linear peak 104 while the minor surfaces 108 intersect the linear peak 104 in a generally perpendicular manner. All of the major and minor surfaces 106, 108 expand in cross-sectional area in a direction away from the circular receiving end 102 and toward the linear peak 104. The inner wedge element 90 further includes receiving holes 112 for receiving and retaining the prongs 110 of the outer housing in order to fix the wedge element 90 in the housing 88.

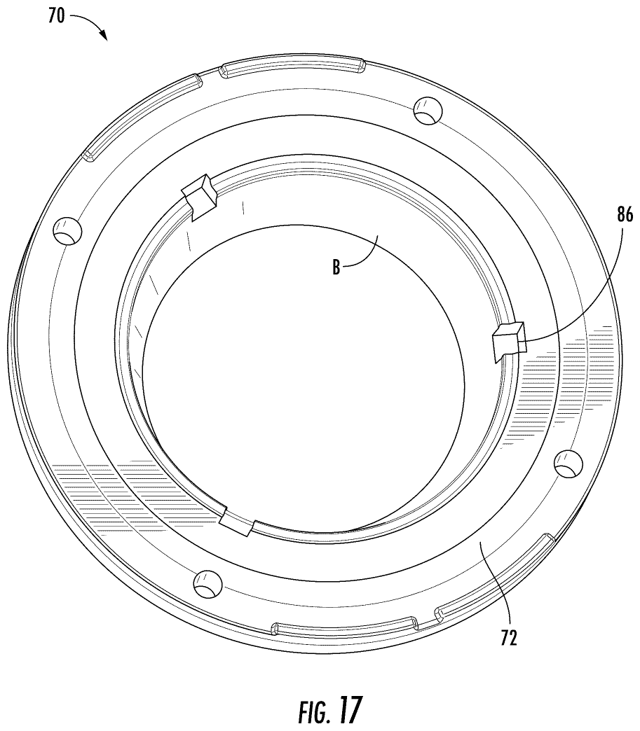

When the second section 50 of the phase plug 34 is assembled, the inner wedge element 90 is received within the outer housing 88 such that the linear peak 104 is disposed within the non-circular cut out 96 on the planar surface 94 of the housing 88 so as to define the non-circular acoustic exit 66. See, e.g., FIG. 20. The circular flange 92 of the outer housing 88 and the circular receiving end 102 of the inner wedge element 90 are aligned in a planar arrangement to facilitate connection with the first section 48 of the phase plug assembly 34. See, e.g., FIG. 21. As noted, the circular flange 92 of the outer housing 88 is received within the mating groove 76 of the outer annular part 70 of the first section 48. Moreover, the circular receiving end 102 of the inner wedge element 90 includes mounting apertures 86 for receiving and retaining the mounting feet 84 (FIG. 18) of the circle portion 82 of the inner annular part 78 of the first section 48 of the phase plug 34. That is, when the inner annular part 78 is seated within the outer annular part 70, as described above, the circular portion 82 and its feet 84 extend into an opening at the center of the outer annular part 70, at which location the feet 84 are received by the mounting apertures 86 of the inner wedge element 90. In this way, the inner wedge element 90 is connected to the inner annular part 78, the outer housing 88 is arranged so as to contain the inner wedge element 90, and the circular flange 92 of the housing 88 is secured within the mating groove 76 of the outer annular part 70, such that the first section 48 of the phase plug assembly 34 is secured to the second section 50.

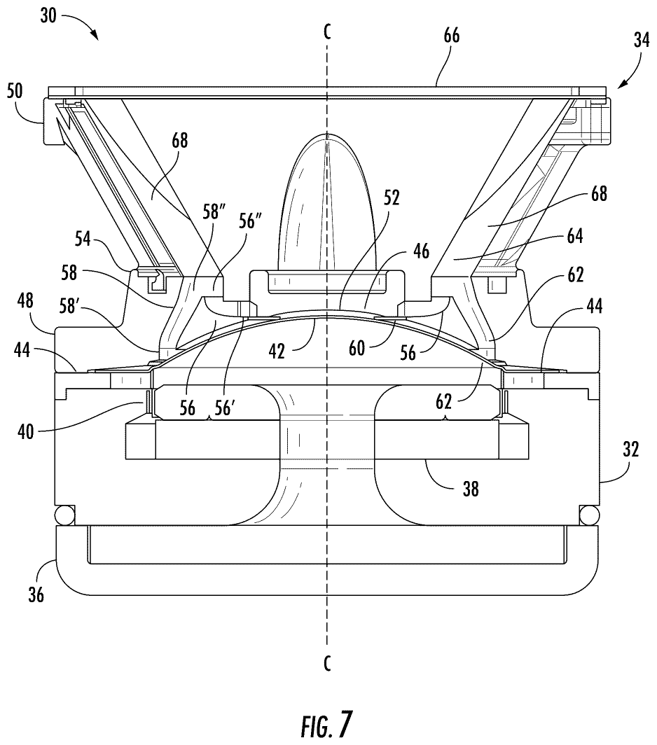

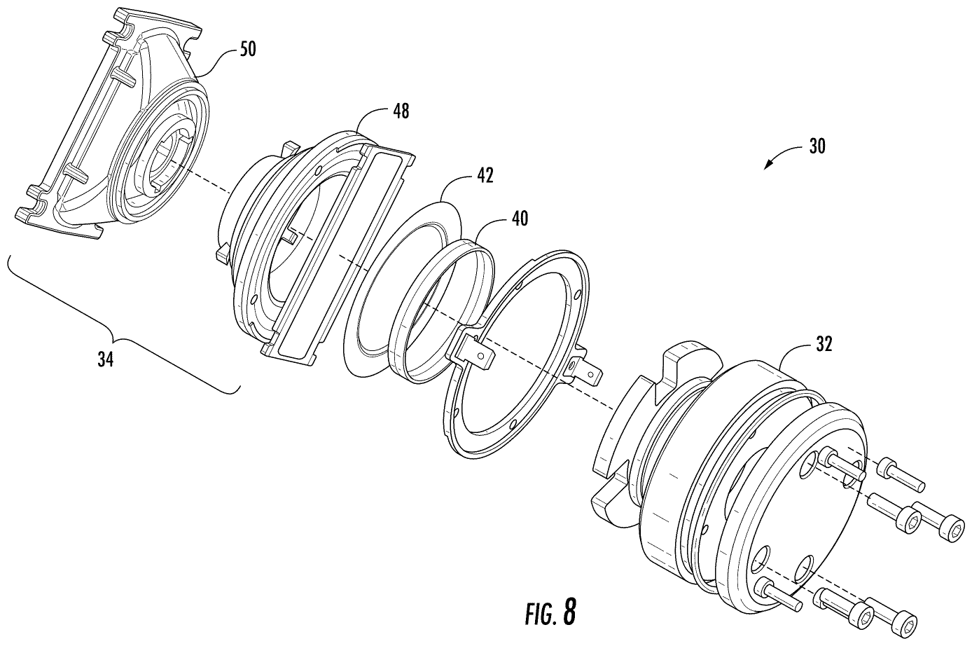

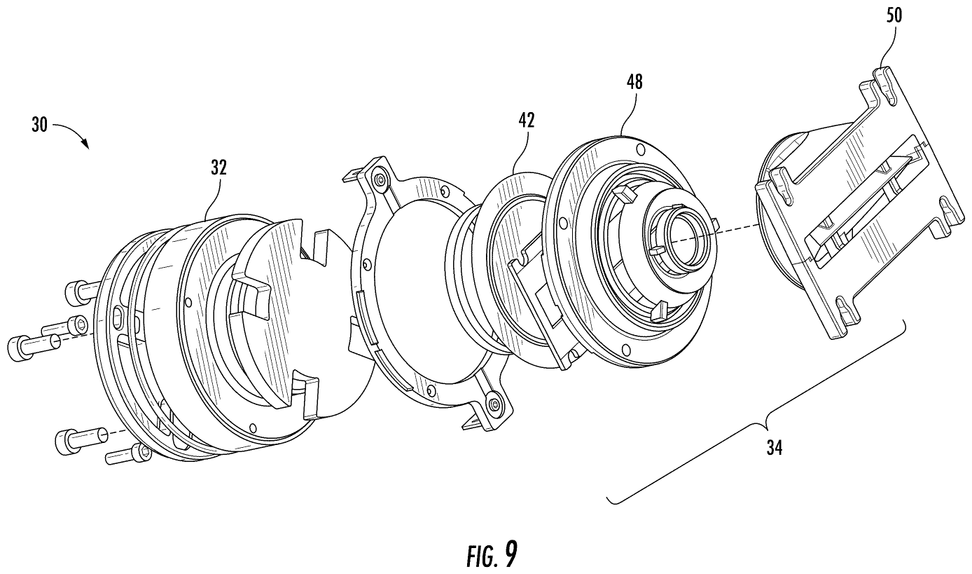

As described above, the passageway 68 extends through the second section 50 of the phase plug 34, from the acoustic entrance 64 to the acoustic exit 66. (FIGS. 5 and 7) This passageway 68 is formed, on the one hand, by the interior surfaces of the outer housing 88 and, on the other hand, by the exterior surfaces of the inner wedge element 90. That is, disposing the inner wedge element 90 within the outer housing 88 defines the second section passageway 68. The inner wedge element 90 is essentially an occluding body disposed within the interior of the second section 50 of the phase plug 34, the passageway 68 being delimited by an outer wall of the occluding body 90 and an inner wall of the second section 50.

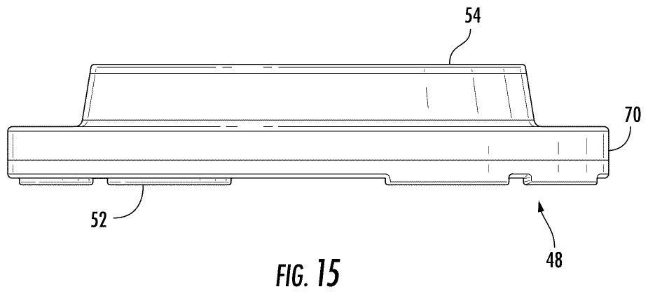

Also as described above, the innermost passageway 56 and the outermost passageway 58 extend through the first section 48 of the phase plug 34, from the boundary face 52 to the termination 54 of the second section 48. The innermost and outermost passageways 56, 58 are formed by seating the inner annular part 78 within the outer annular part 70. Here again, the inner annular part 78 is essentially an occluding element disposed within an interior of the annular part 70 to form the desired acoustic pathways. Particularly, with reference to FIGS. 16-18, an outer surface A of the ring portion 80 and an inner surface B of the annular part 70, along with the gap G2, define the outermost passageway 58. An inner surface C of the ring portion 80, an outer surface D of the circle portion 82, and the gap G1 define the innermost passageway 56.

In one embodiment, the passageway 68 of the second section 50 of the phase plug 34 comprises a cross sectional area at the acoustic entrance 64 that is about 75% of a cross sectional area of the second section passageway 68 at the acoustic exit 66.

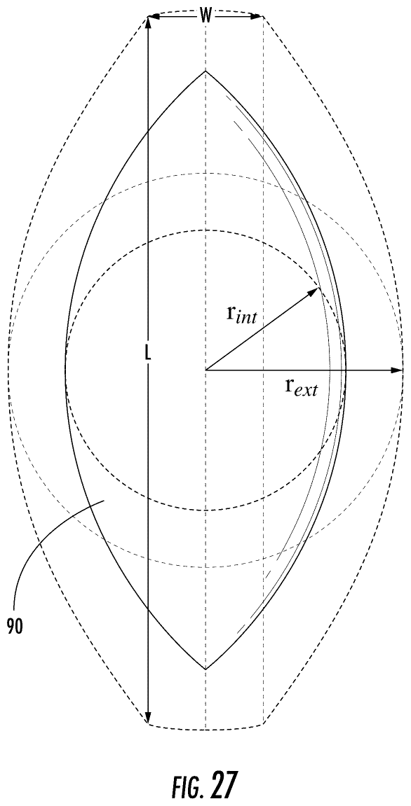

The size and dimensions of the inner wedge element may be varied and determined based upon a particular need or application. With reference to FIG. 27 one method of design parameterization for optimizing acoustic output, in order to have a final flat wavefront at the acoustic exit 66, involves relating interior and exterior radii of the wedge element with its length and width according to the following:

$${r}_{int} = \frac{1}{4} ( L - w )$$

$${r}_{e x t} = \frac{1}{4} ( L + w )$$

$$where ,$$

$${A}_{circle} ∼ \frac{3}{4} {A}_{slot}$$

and where angle α is chosen as desired.

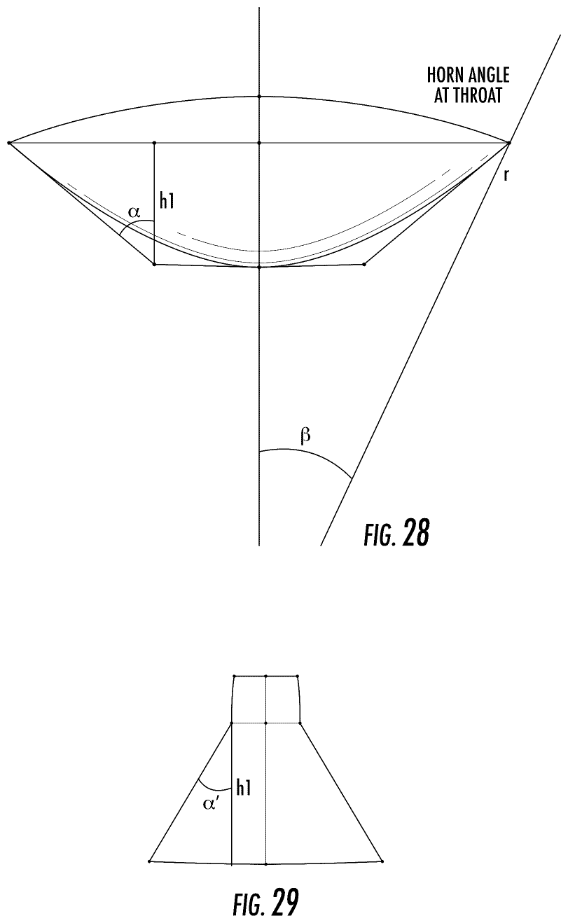

FIGS. 27-29 represent the air volume surrounding the inner wedge element and depict schematic wavefront details of the wedge, but not the structure of the wedge itself. That is, FIGS. 27-29 are simulations depicting negatives of the wedge structure in order to illustrate acoustic wavefront behavior thereof. The exemplary wavefronts illustrated are curved and align with the embodiments of a bent inner wedge element 120, described below.

The phase plug 34 described herein may include a second mechanical sub-assembly comprising additional mechanical structure to further control the shape of the wavefront for the wavelengths of interest. Such additional mechanical structures are obstacles that can be added inside the assembly described herein to further control sound waves in the second section of the phase plug 34. The desired wavefront shape (pressure distribution) at the acoustic exit 66 can be planar or curved, depending upon the requirements of the specific final application.

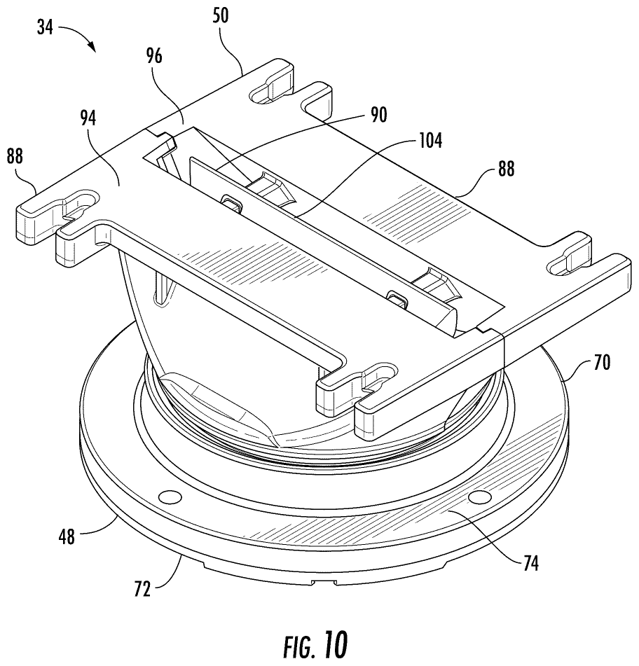

Thus far, the acoustic exit 66 of the phase plug assembly 34 has been illustrated as rectangular. See, e.g., FIGS. 10-11. This, of course, is merely exemplary. The acoustic exit 66 may assume any non-circular shape as desired for a particular application of the loudspeaker assembly 30.

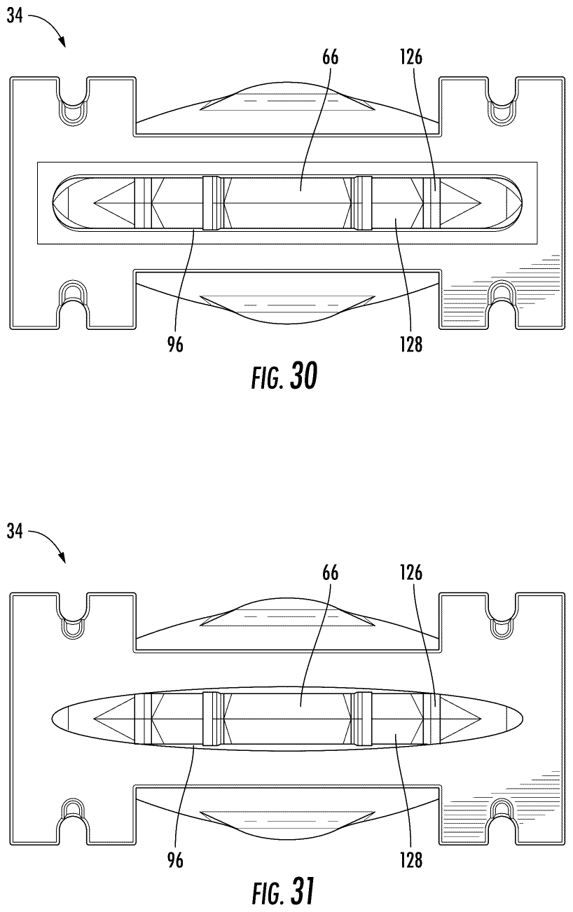

For example, FIGS. 30-31 depict a further embodiment of the phase plug 34 in which the acoustic exit 66 is obround shaped and oval shaped, respectively. This is accomplished simply by re-shaping the non-circular cut-out 96 as desired to achieve the respectively shaped acoustic exit 66. Other non-circular shapes are contemplated for the acoustic exit 66, under the broad scope of the invention. The phase plugs illustrated in FIGS. 30-31 include internal partitions described more in detail below. This ‘multicellular’ version of the phase plug may include the illustrated obround or oval shaped acoustic exit, or a rectangularly shaped acoustic exit. Similarly, the previously discussed ‘non-multicellular’ version of the phase plug, without internal partitions, may include the rectangular shaped acoustic exit, or the obround or oval shapes shown in FIGS. 30-31.

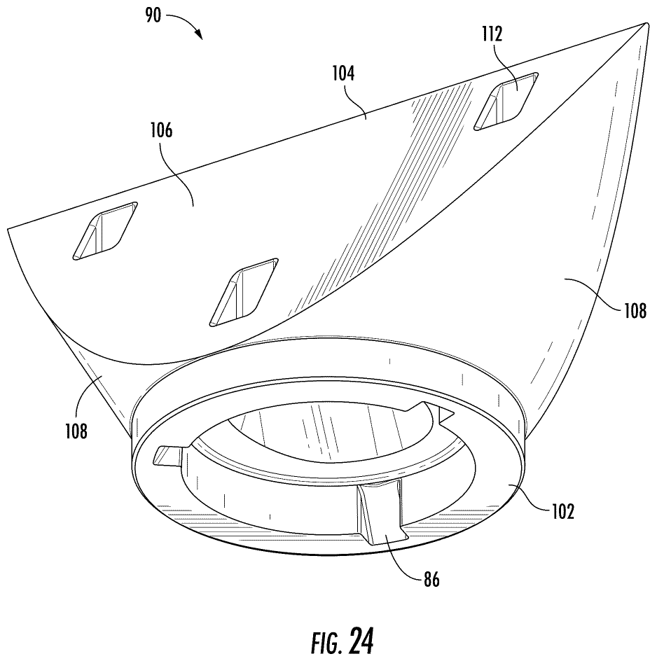

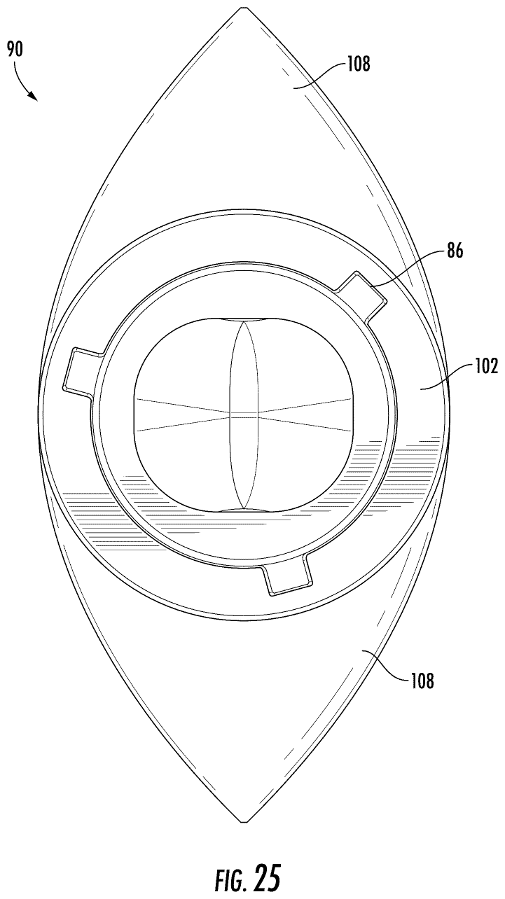

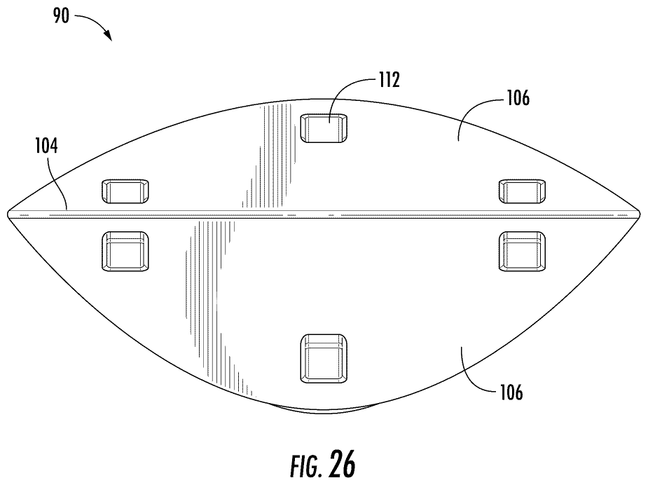

As disclosed herein, the second section 50 of the phase plug assembly 34 comprises an outer housing 88 and an inner wedge element 90. See, e.g., FIGS. 20-21. The inner wedge element 90 is described herein as comprising a circular receiving end 102 on one side and a linear peak 104 on an opposing side. See, e.g., FIGS. 24-26. The major surfaces 106 extend from the circular receiving end 102 in a planar fashion to the linear peak 104, while minor surfaces 108 extend in a curved fashion from the circular receiving end 102 to opposing ends of the linear peak 104. The result is a generally wedge shaped, or axe head shaped element having a peak 104 extending linearly across an upper boundary, opposite from the circular receiving end 102.

This of course is merely one exemplary embodiment of the inner wedge element. The broad scope of the invention contemplates further embodiments thereof for use within the phase plug assembly 34.

For example, as noted above, the receiving end 102 may be non-circular in shape. That is, the receiving end 102 may be oval, obround, elliptical, rounded square, etc. as necessary to help define the geometry of the virtual transition plane V-V between the first section termination of the phase plug 54, and the passageway 68 of the second section of the phase plug 34.

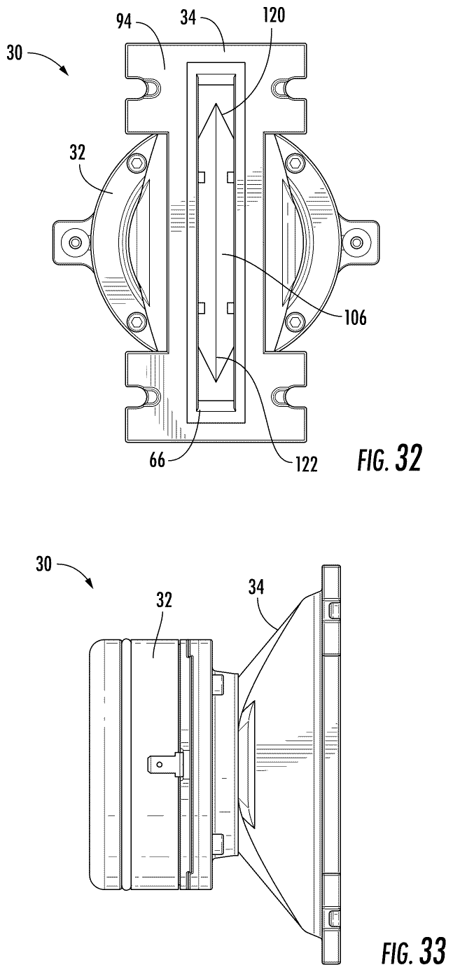

In a further example, FIGS. 32-34 show the loudspeaker assembly 30 in an alternate embodiment having a bent inner wedge element 120 including the circular receiving end 102 and the major and minor surfaces 106, 108 described previously with respect to the inner wedge element 90. However, instead of the linear peak 104 of the inner wedge element 90, the bent inner wedge element 120 comprises a curved upper surface 122 which extends along the major surfaces 106, from one minor surface 108 to the opposite minor surface 108.

The bent inner wedge element 120 may be a one piece, monolithically formed element. Alternatively, the element 120 may comprise two or more separate elements that are affixed together, e.g. mechanically, or they may be adhered or fastened together.

The bent inner wedge element 120 is disposed in the second section 50 of the phase plug assembly 34 similarly to the inner wedge element 90. That is, when the second section 50 of the phase plug 34 is assembled, the bent inner wedge element 120 is received within the outer housing 88 such that the curved upper surface 122 is disposed within the non-circular cut out 96 on the planar surface 94 of the housing 88 so as to form the non-circular acoustic exit 66. The circular flange 92 of the outer housing 88 and the circular receiving end 102 of the bent inner wedge element 120 are aligned in a planar arrangement to facilitate connection with the first section 48 of the phase plug assembly 34. See, e.g., FIGS. 16 and 21. As previously described, the circular flange 92 of the outer housing 88 is received within the mating groove 76 of the outer annular part 70 of the first section 48. Moreover, the circular receiving end 102 of the bent inner wedge element 120 may include mounting apertures for receiving and retaining the mounting feet 84 of the circle portion 82 of the inner annular part 78 of the first section 48 of the phase plug 34. That is, when the inner annular part 78 is seated within the outer annular part 70, as described above, the circular portion 82 and its feet 84 extend into an opening at the center of the outer annular part 70, at which location the feet 84 are received by the mounting apertures 86 of the bent inner wedge element 120. In this way, the bent inner wedge element 120 is connected to the inner annular part 78, the outer housing 88 is arranged so as to contain the bent inner wedge element 120, and the circular flange 92 of the housing 88 is secured within the mating groove 76 of the outer annular part 70, such that the first section 48 of the phase plug assembly 34 is secured to the second section 50.

As illustrated in FIGS. 32-34, an apex of the curved upper surface 122 of the bending inner wedge element 120 is aligned with and is generally tangent to the planar surface 94 of the outer housing 88 of the second section 50 of the phase plug 34. In another arrangement, all or a portion of the curved surface 122 may extend from the non-circular cut out 96 on the planar surface 94 of the housing 88. Alternatively, the outer housing may be truncated in such a manner that all or a portion of the curved surface 122 and the arcuate solid 124 may extend therefrom to form the non-circular acoustic exit 66.

The bent inner wedge element 120 is configured to achieve a curved wavefront at the output of the phase plug 34. This bent configuration produces a widening of high frequencies but possibly some loss of angular evenness in directional control in the mid-high frequencies. This mid-high frequency issue can be mitigated by use of a multicellular bent element discussed below and/or by reducing the horn angle moderately, in order to retain consistent directionality of through the frequency spectrum.

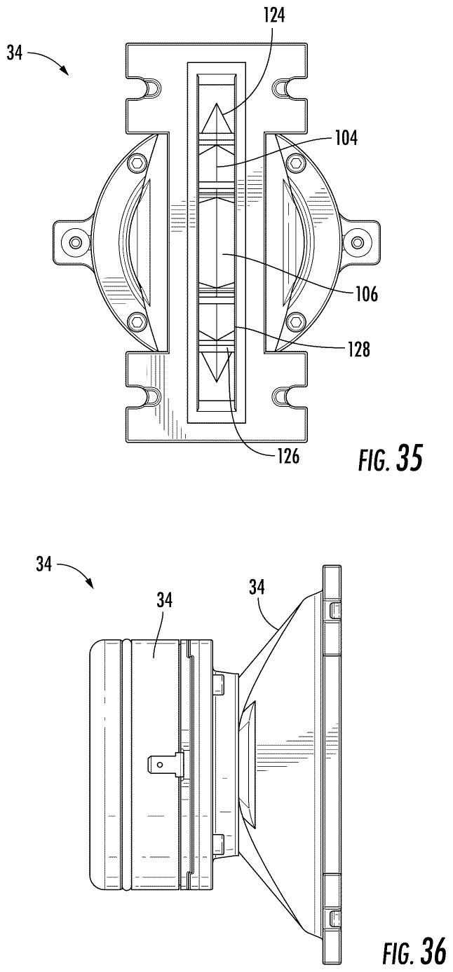

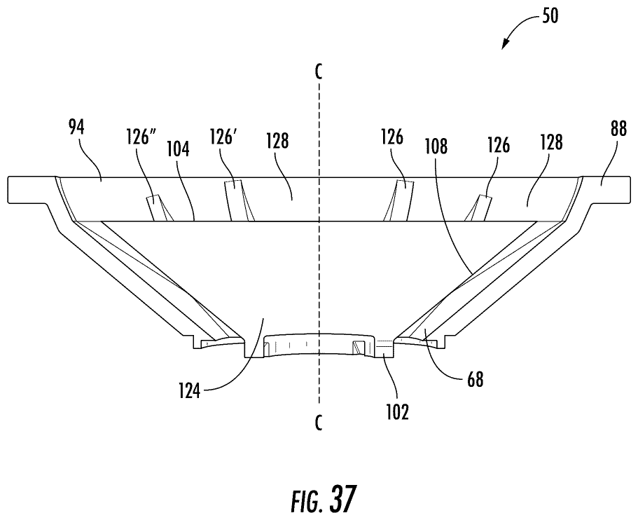

In another embodiment, as shown in FIGS. 35-41, the loudspeaker assembly 30 may include a multicellular bent inner wedge element 124. Here, the wedge element 124 has an axe head shape similar to the inner wedge element 90 described above, with a circular receiving end 102, a linear peak 104, major planar surfaces 104, and curved minor surfaces 106. However, unlike the inner wedge element 90 of FIG. 10 et al., in which the linear peak 104 aligns with the non-circular cut 96 at the planar surface 94 of the phase plug second section 50, the linear peak 104 of the multicellular inner wedge element 124 is inset into the housing 88, vertically offset from the planar surface 94 along the axis C-C. The multicellular inner wedge element 124 is characterized as being defined by internal dividers, as discussed further below. The multicellular bent inner wedge element 124 provides enhanced mid-high frequency control. Particularly, the multicellular configuration described herein is directed at controlling an expansion rate of sound waves in the passageway 68 of the second section 50 of the phase plug 34. The multicellular structure guides the wavefront in the correct manner for certain problematic frequencies where e.g. diffraction effects impact the evenness of the sound dispersion.

Multicellular, in the present context, generally refers to additional structural elements within the second section 50 of the phase plug 34. In one embodiment, a plurality of vanes 126 are disposed between the major surfaces 106 of the multicellular inner wedge element 124 and an inner wall of the outer housing 88.

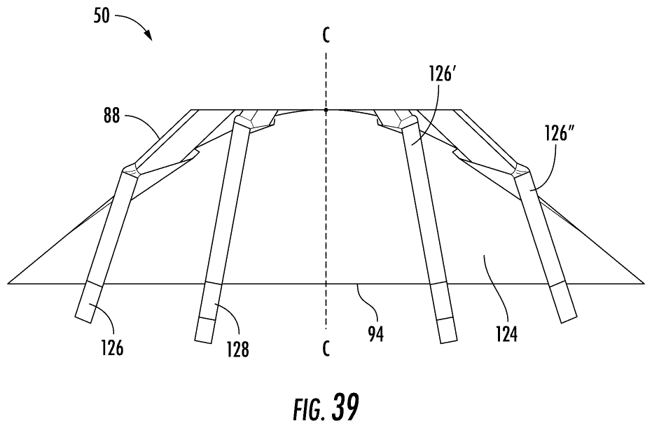

For example, FIGS. 35-38 show an embodiment of the multicellular inner wedge element 124 bent disposed within the outer housing 88 (previously discussed in detail with reference to FIGS. 20-23). This embodiment of the multicellular inner wedge element 124 bent includes the vanes 126 traversing along the major surfaces 106 of the wedge 124 and extending from the linear peak 104 generally in the direction of axis C-C. In the illustrated embodiment, the vanes 126 include two central vanes 126′ and two outer vanes 126″. The inner vanes 126′ are both equidistant from the axis C-C. The outer vanes 126″ are similarly both equidistant from the axis C-C. The distance between the outer vanes 126″ and the axis C-C is greater than the distance between the inner vanes 126′ and the axis C-C. All of the vanes 126 are angled away from the axis C-C. For example, as shown schematically in FIG. 39, the inner vanes 126′ are positioned at angle of about ⅓ of the horn angle β, whereas the outer vanes 126″ are disposed at an angle of about ⅔ of the horn angle β.

The vanes 126 extend between the major surfaces 106 of the multicellular inner wedge element 124 and the inner wall of the outer housing 88, effectively dividing the second section passageway 68 within the phase plug 34 into a plurality of channels 128. In the illustrated embodiment, the inner and outer vanes 126′, 126″ form five channels 128. The vanes 126 may be formed integrally with multicellular inner wedge element 124, and extend therefrom to engagingly contact the inner surface of the outer housing 88, thus forming the channels 128. Alternatively, the vanes 126 may be an integral portion of the outer housing 88 and extend from the inner wall to engagingly contact the major surfaces 106 of the multicellular inner wedge element 124, thus forming the channels 128. Still further alternatively, some vanes 126 may be formed integrally with the housing 88 while others are formed integrally with the multicellular inner wedge element 124. In another alternative, the vanes may be constructed as a piece separate from the multicellular inner wedge element 124 and the outer housing 88 and may be inserted there between in a friction fit or secured with adhesive or fastening, to thus form the channels 128.

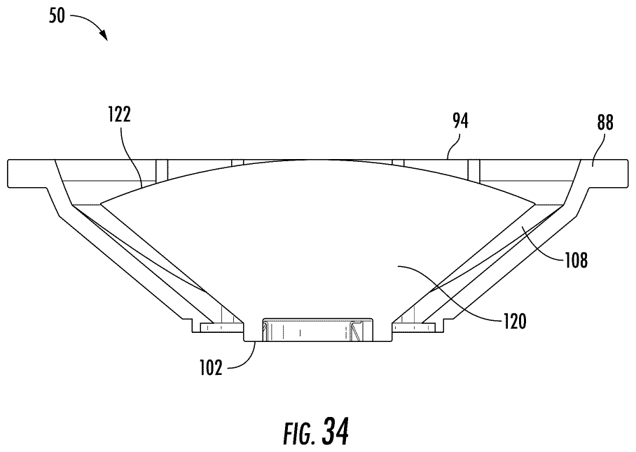

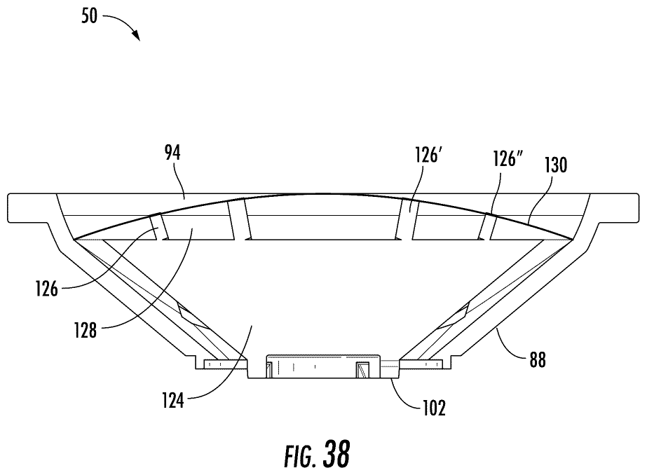

As can be seen in FIGS. 37-38, the inner vanes 126′ extend further in the direction of the axis C-C then the outer vanes 126″. That is, the inner vanes 126′ extend to the planar surface 94 of the outer housing 88, or at least close thereto. The outer vanes 126″ do not extend to the surface 94 and instead terminate at about a midpoint between the linear peak 104 of the multicellular inner wedge element 124 and the surface 94. This has the effect of creating an effective bent exit 130 for the channels 128 which mimics the curved upper surface 122 of the bent inner wedge element 120 of FIG. 34. The result of both the curved upper surface 122 and the effective bent exit 130 is that the respective phase plugs 34 propagate a curved acoustic wavefront.

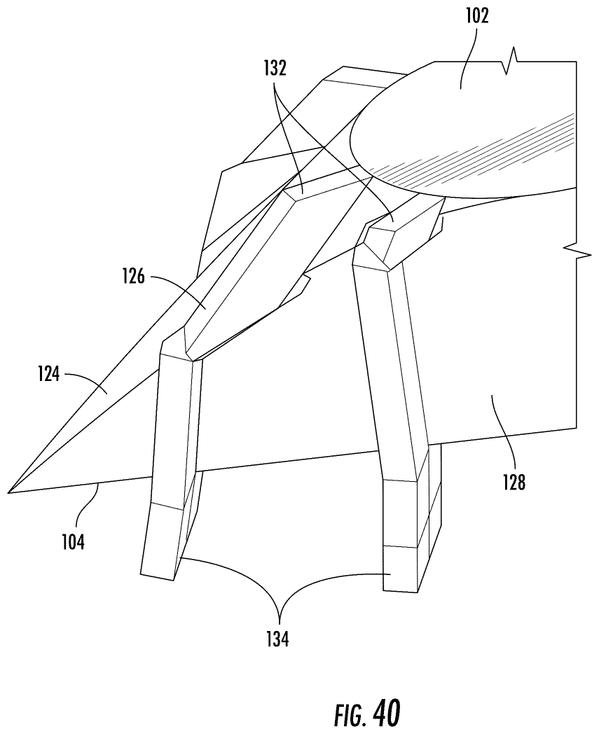

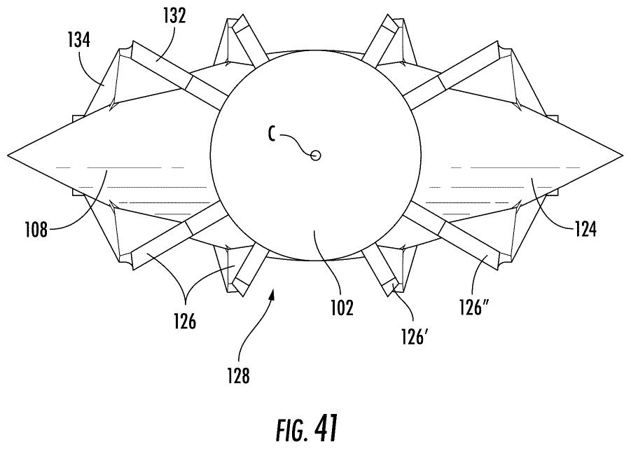

FIGS. 40-41 show an embodiment of the multicellular inner wedge element 124 where the vanes 126 each include a first portion 132 extending from the circular receiving end 102 and a second portion 134 extending from the first portion 132 toward the linear peak of the multicellular inner wedge element 124. The first portions 132 extend at least partially across the minor surfaces 108 of the multicellular inner wedge element 124 and the second portions 134 extend upon the major surfaces 106. As can be seen in FIG. 41, the vanes 126 are spaced about the axis C-C at about 30°.

The description of the multicellular inner wedge element 124 provided thus far is merely exemplary. The invention contemplates variations and permutations of the parameters forming the wedge element 124. The number of vanes 126, their particular disposition within the housing 88, their length of extension relative to the linear peak 104 of the inner wedge element 124, and their angles with respect to the axis C-C and with respect to each other, are described herein by way of example only and may be varied and altered as desired for a particular application.

As previously described, FIGS. 30-31 illustrate the phase plug 34 having alternatively shaped acoustic exits 66. It is noted that these embodiments of the phase plug 34 also include the vanes 126 which divide second section passageway into the multiple channels 128. However, the phase plug according to this disclosure may include any combination of the various acoustic exit shapes and any of the various inner wedge geometries, with or without vanes, as desired for a particular application.

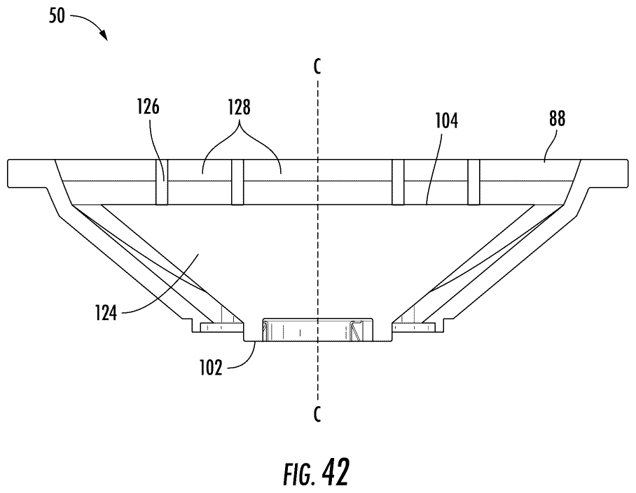

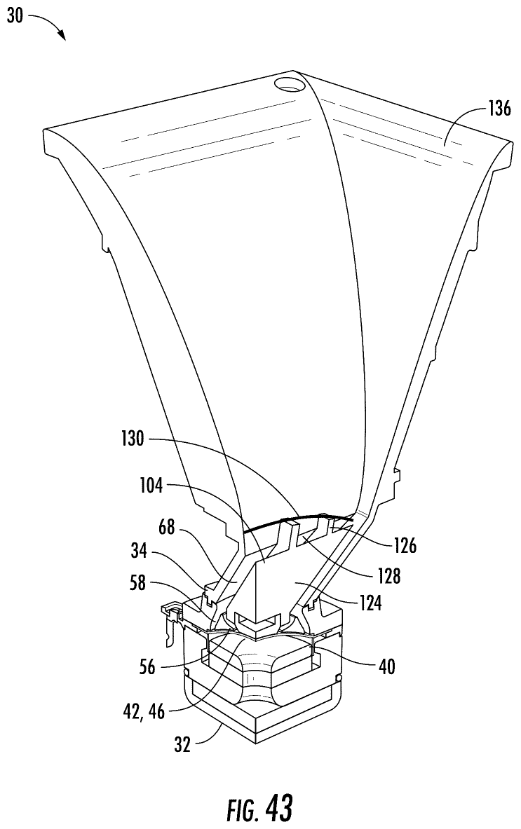

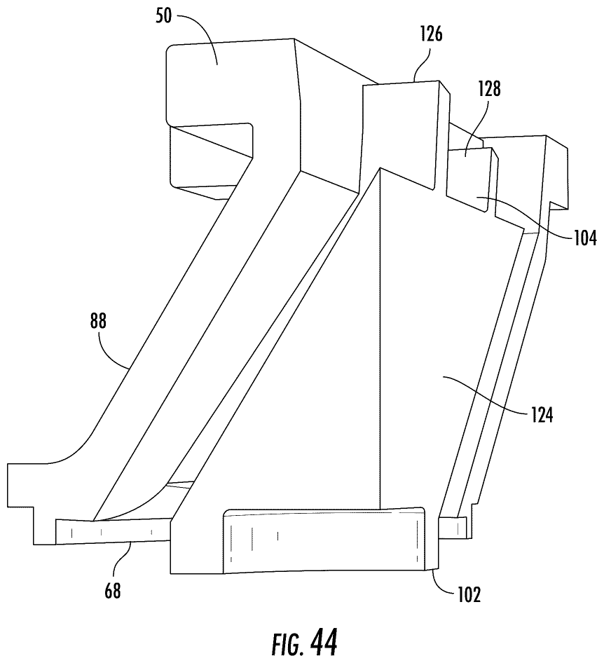

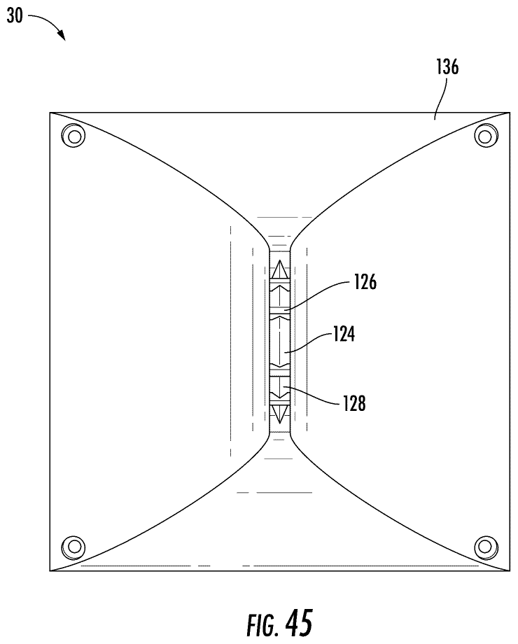

FIG. 42 shows an alternative embodiment of a multicellular inner wedge element 124 having the linear peak 104 and a plurality of vanes 126 extending parallel to the axis C-C, where all vanes extend to and terminate at the planar surface 94 of the outer housing 88. The result are channels 128 which are generally aligned with the axis C-C thus presenting a planar waveform at the acoustic exit of the phase plug 34. FIGS. 43-45 show views of the phase plug 34, having the multicellular inner wedge element 124, attached to a horn 136 to form the loudspeaker 30 assembly. The horn 136 is shaped and configured to direct sound propagating from the acoustic exit 66 in a direction away from the loudspeaker assembly 30. The horn 136 may be an integral part of the outer housing 88, or a separate structure. The bent exit 130, created by the different length inner and outer vanes 126′, 126″ is indicated in FIG. 43. FIG. 44 shows a partial enlarged view of the multicellular inner wedge element 124 and the housing 88 of the second section 50 of the phase plug 34. FIG. 45 provides a view into the horn 136 in which can be seen the acoustic exit 66 of the phase plug 34, the multicellular inner wedge element 124, the vanes 126, and the channels 128.

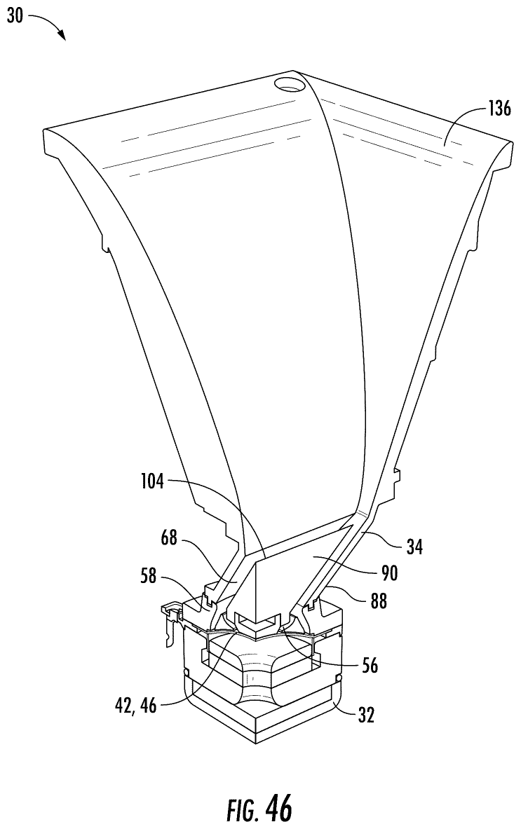

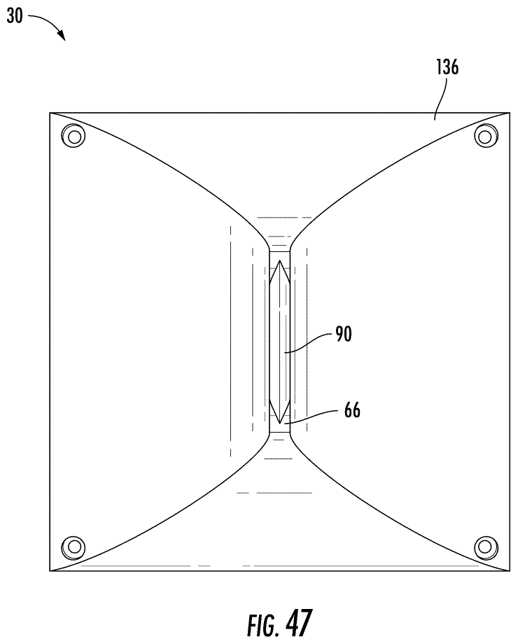

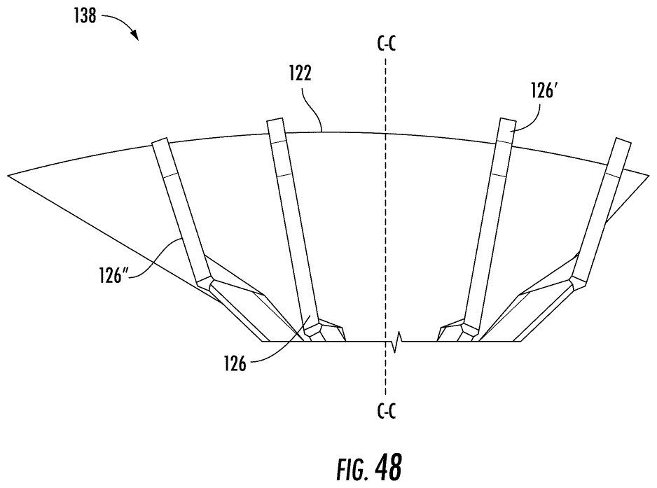

FIGS. 46-47 show an embodiment of the loudspeaker assembly 30 which is non-bent and non-multicellular. That is, the illustrated assembly 30 includes the non-bent inner wedge element 90, without the vanes 126, disposed within the outer housing 88 which is attached to the horn 136.

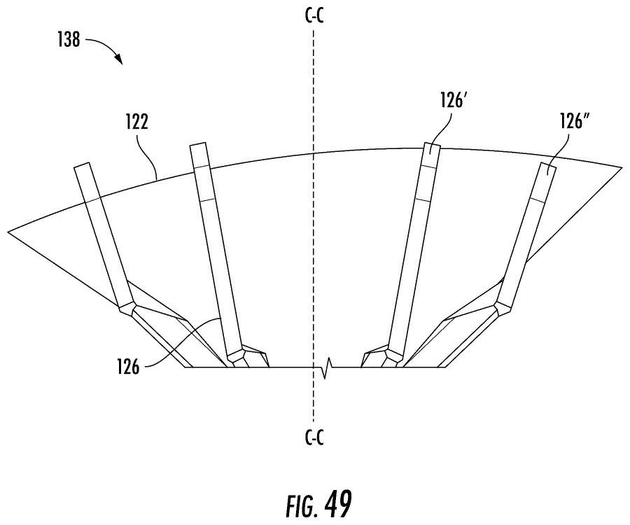

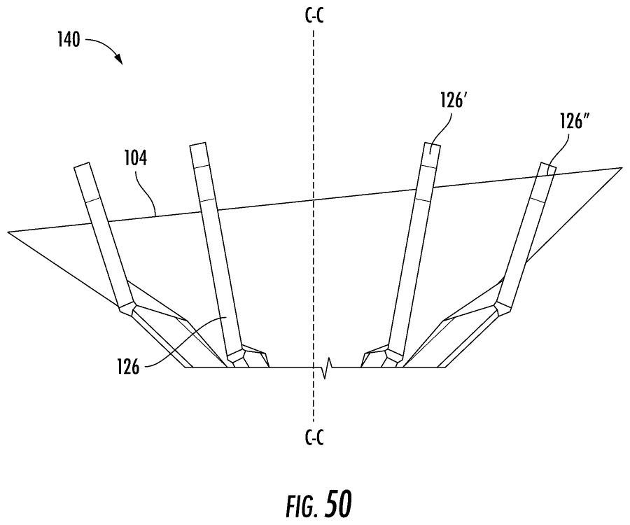

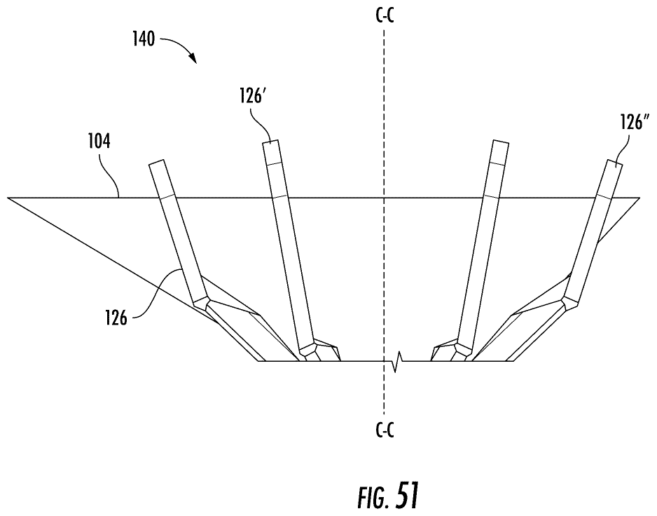

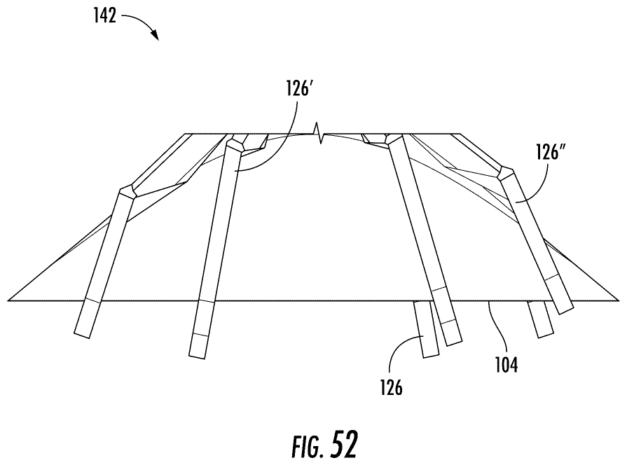

Thus far, the various inner wedge elements 90, 120, 124 have been described and illustrated as being shaped symmetrically about the central axis C-C of the phase plug 34. However, in other embodiments of the invention, the phase plug 34 may include an asymmetric inner wedge element. For example, FIGS. 48-49 show a bent asymmetric multicellular inner wedge element 138 having the curved upper surface 122 and a plurality of vanes 126 comprising the inner and outer vanes 126′ and 126″, described above. As illustrated, the vanes 126 are arranged symmetrically about the central axis C-C, but the volume forming the wedge 138 is distributed asymmetrically about the axis C-C. FIGS. 50-51 show an asymmetric multicellular inner wedge element 140 having the linear peak 104 described above with regard to the inner wedge element 90. Here again, the vanes 126 are distributed symmetrically about the central axis C-C, but the wedge 140 itself is shaped asymmetrically about the axis C-C.

The vanes 126 of the various multicellular inner wedge elements 124, 138, 140 have been described herein as radiating symmetrically about the central axis C-C of the phase plug 34. However, in alternative embodiments, one or more of the vanes 126, 126′, 126″, may be arranged asymmetrically about the axis C-C.

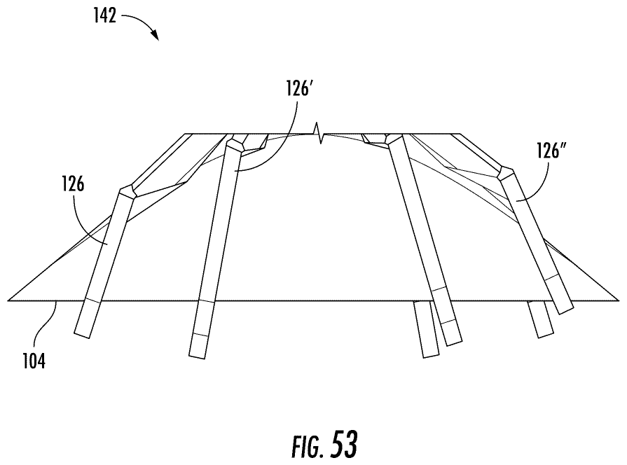

For example, FIGS. 52-53 illustrate alternative embodiments of a multicellular inner wedge element 142 having the linear peak 104 where the vanes 126 are arranged asymmetrically about the central axis of rotation C-C. In these configurations, the angular spacing between adjacent vanes may vary, with some vanes 126 positioned at angles corresponding to fractions of the horn opening angle β. For example, in FIG. 52, inner vanes 126′ may be positioned at angles ranging from β/2 to β/4 relative to the central axis C-C, while outer vanes 126″ may be positioned at angles ranging from β/2 to 3/4β. In the embodiment of FIG. 53, inner vanes 126′ may be positioned at angles of β/4, β/3, or β/2 relative to the central axis C-C, while the outer vanes 126″ are arranged at β/2, β/3 or 3/4β. These asymmetric arrangements can be advantageous for optimizing acoustic performance and controlling directivity patterns in specific applications. The shape of the wedge element 142, as illustrated in FIGS. 52-53, is symmetric with the non-bent linear peak 104. However, in other embodiments, the wedge element 142 may be shaped asymmetrically and may include the linear peak 104 of the curved upper surface 122 of the bent version of the wedge.

The asymmetric shape of the inner wedges 138, 140 in FIGS. 48-51 and the asymmetric arrangement of the vanes 126 in FIGS. 52-53 provide that the dispersion above and below the centerline axis of the second section of the phase plug could have different angles. That is, a midpoint angle of the vertical dispersion would be pointed from purely horizontal, without having to physically mount the driver onto a horn flare where the mounting face of the horn throat places the compression driver at an angle above or below the horizontal.

The phase plug assembly described herein provides a non-circular acoustic exit useful in loudspeaker vertical or horizontal arrays without requiring an intervening element or adapter 26 extending between a phase plug of a compression driver and the acoustic exit, and also addresses and tempers unwanted compression chamber modal behavior, thus overcoming the problems of the prior art and ensuring optimal sound directivity and quality in a compact and simplified structure.

The arrangement of at least two passageways in the first section of the phase plug assembly, with each passageway expanding in cross-sectional area from the boundary face to the termination, ensures equidistant path length and similar acoustic impedance of the at least two passageways at their meeting at the virtual plane V-V and minimizes modal behavior within the compression chamber. By aligning the entrances of the passageways with the nodes of the axial modes of the compression chamber, modal activity is suppressed, leading to improved sound quality. The use of circular, oval, or obround annuli shapes at the termination provides flexibility in tailoring the acoustic output to specific applications, controlling directivity and reducing unwanted fluctuations in the angular dispersion of sound waves. This design eliminates the need for an additional component 26, thereby reducing the overall size and complexity of the loudspeaker system while maintaining high acoustic performance. Further benefits are seen with reduced distortion within the loudspeaker due to the reduction in passage distance from the compression chamber to the mouth of the phase plug affixed to a radiating waveguide or other impedance matching assembly.

The second section of the phase plug assembly, with the acoustic entrance aligned to the termination of the first section and the acoustic exit shaped as a rectangular, filleted rectangular, obround, or oval form, facilitates the transformation of the wavefront into a desired non-circular shape. This transformation enables precise control of sound directivity, particularly in vertical or horizontal loudspeaker arrays. The expanding surface area of the second section passageway ensures efficient acoustic energy transfer while minimizing reflections and diffraction effects that can cause variations in the directivity. The propagation delay, introduced by the varying lengths along the occluding body of the second section passageway, allows for fine-tuning of the acoustic phase, ensuring that the wavefront radiating from the acoustic exit is optimized for the intended application. This integrated design eliminates the need for external adapters, reducing acoustic inefficiencies and maintaining a compact loudspeaker configuration.

The phase plug assembly provided herein with a bent exit that is formed by inner and outer vanes of varying dispersion angles and termination points introduces a controlled curvature to the wavefront at the acoustic exit. The bent exit, created by the differential lengths of the inner and outer vanes, modifies the propagation path of acoustic waves, resulting in a curved wavefront at the acoustic exit. This curvature enhances the directivity of sound waves when coupled with a specific horn, allowing for improved sound dispersion and coverage in applications such as vertical or horizontal loudspeaker arrays. The differential vane lengths create a gradual transition in the wavefront shape, which reduces abrupt changes in acoustic impedance and minimizes reflections and diffraction losses within the phase plug, leading to a more coherent and uniform sound output. The curved wavefront generated by the bent exit improves the control of high-frequency sound propagation, enabling precise tuning of the acoustic output to match the requirements of specific applications, such as concert halls or outdoor venues, and mitigates mid-frequency issues by optimizing the occluding body geometry and exit configuration. This bent exit configuration enables a compact design while maintaining high acoustic performance, removing the requirement for additional external components such as waveguides or adapters, and minimizing the overall dimensions and intricacy of the loudspeaker system, rendering the design appropriate for applications with limited space while preserving sound quality.

Various embodiments of the present invention are described herein with reference to the related drawings. Alternative embodiments can be devised without departing from the scope of this invention. It is noted that various connections and positional relationships (e.g., over, below, adjacent, etc.) are set forth between elements in the description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship.

The term “exemplary” is used herein to mean “serving as an example, instance, or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The term “a plurality” is understood to include any integer number greater than or equal to two, i.e., two, three, four, five, etc. Terms such as “connected to”, “affixed to”, etc., can include both an indirect “connection” and a direct “connection.”

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A phase plug assembly for an electrodynamic compression driver, including a first and a second section, where the first section comprises:
a. a compression chamber formed by a convex or concave oscillating diaphragm and a boundary face of the phase plug assembly arranged adjacent to the diaphragm;
b. a central axis of rotation, defined within an interior of phase plug assembly which extends from the boundary face of the compression chamber to a termination of the phase plug assembly;
c. at least two passageways, each of which extends about the central axis and traverses through the first section of the phase plug assembly from the boundary face to the termination of the first section, said at least two passageways comprising an innermost passageway and an outermost passageway disposed radially outward of the innermost passageway;
d. wherein the termination of the first section of the phase plug is displaced vertically from the boundary face of the first section of the phase plug along the central axis;
e. wherein each of the passageways expands in cross sectional area between a respective entrance at the boundary face of the first section of the phase plug assembly and the termination of the first section;
f. wherein a length of the outermost passageway from the entrance at the boundary face to the termination of the first section is equivalent to a corresponding length of the inner passageway, where said length is defined by a pathlength along a centerline of the passageway;
g. wherein at the termination the first section of the phase plug, the passageways are arranged in a plane normal to the central axis and vertically displaced from the compression chamber;
h. wherein a shape of the passageways, as defined at the termination of the first section of the phase plug assembly, and as viewed along the central axis, form circular annuli, oval annuli, or obround annuli.

2. The phase plug assembly of claim 1, wherein the second section comprises:
a. an acoustic entrance disposed at the termination of the first section of the phase plug;
b. an acoustic exit, vertically displaced from the acoustic entrance along the central axis and having an exit shape that is rectangular, filleted rectangular, obround, or oval;
c. at least one second section passageway that traverses through an interior of the second section of the phase plug assembly from the acoustic entrance to the acoustic exit;
d. wherein the acoustic exit is shaped to radiate acoustic energy from the phase plug assembly into free space, a horn, a waveguide, or other acoustic impedance matching device;
e. wherein a total surface area of the second section passageway expands between the acoustic entrance and the acoustic exit;
f. wherein a length along the second section passageway determines a propagation delay through the second section of the phase plug to control an acoustic phase of a wavefront radiating from the acoustic exit.

3. The phase plug assembly of claim 1, wherein the first section comprises a first mechanical sub-assembly that defines the passageways of the first section and is mechanically discontinuous and separable from the second section of the phase plug assembly.

4. The phase plug assembly of claim 2, wherein the second section comprises a second mechanical sub-assembly that defines the acoustic entrance and acoustic exit of the second section and is mechanically discontinuous and separable from the first section of the phase plug assembly.

5. The phase plug of assembly claim 1, wherein the diaphragm comprises an axis of rotation that coincides with the central axis of rotation of the phase plug assembly.

6. The phase plug assembly of claim 2, wherein the passageway through the second section of the phase plug is defined by an occluding body disposed within the interior of the second section of the phase plug, the passageway delimited by an outer wall of the occluding body and an inner wall of the second section.

7. The phase plug assembly of claim 4, wherein the second mechanical sub-assembly comprises additional mechanical structure to further control the shape of the wavefront for frequencies where the vertical dispersion pattern narrows or widens.

8. The phase plug assembly of claim 1, wherein the entrance of the innermost and outermost passageways at the boundary face of the first section of the phase plug assembly is located at a node location of an axial acoustic mode of the compression chamber.

9. The phase plug assembly of claim 2, wherein the second section passageway comprises a cross sectional area at the acoustic entrance that is about 75% of a cross sectional area of the second section passageway at the acoustic exit.

10. The phase plug assembly of claim 6, wherein the occluding body is wedge shaped and comprises a circular receiving end disposed proximate to the acoustic entrance of the second section.

11. The phase plug assembly of claim 10, wherein the occluding body comprises a linear peak disposed at the acoustic exit of the second section, opposite from the circular receiving end.

12. The phase plug assembly of claim 11, wherein the outer wall of the occluding body comprises opposed major planar surfaces which extend from the circular receiving end to the linear peak and which extend along the linear peak from a first end thereof to a second thereof.

13. The phase assembly plug of claim 12, wherein the outer wall of the occluding body further comprises opposed minor curved surfaces which extend from the circular receiving end to the first and second ends of the linear peak respectively.

14. The phase assembly plug of claim 10, wherein the occluding body comprises a curved upper surface disposed at the acoustic exit of the second section, opposite from the circular receiving end.

15. The phase assembly plug of claim 6, wherein the occluding body includes a multicellular structure.

16. The phase assembly plug of claim 15, wherein the multicellular structure comprises a plurality of vanes extending between the outer wall of the occluding body and the inner wall of the second section.

17. The phase assembly plug of claim 16, wherein the plurality of vanes extends through the second section passageway, from the acoustic entrance to the acoustic exit.

18. The phase assembly plug of claim 17, wherein the plurality of vanes divide the second section passageway into a plurality of channels.

19. The phase plug assembly of claim 18, wherein the occluding body is wedge shaped with opposed major surfaces that are generally planar and opposed minor surfaces that are generally curved, the major surfaces have a surface area greater than a surface area of the minor surfaces, wherein the vanes extend across the opposed major surfaces.

20. The phase plug assembly of claim 19, wherein the occluding body comprises a circular receiving end disposed proximate to the acoustic entrance of the second section and a linear peak, formed by an intersection of the major planar surfaces, disposed at the acoustic exit of the second section, opposite from the circular receiving end.

21. The phase plug assembly of claim 20, wherein the plurality of vanes comprise two inner vanes and two outer vanes, the inner vanes being disposed radially inward of the outer vanes relative to the central axis, the inner vanes extending a first distance from the linear peak to the acoustic exit, the outer vanes extending a second distance from the linear peak to the acoustic exit, the first distance being greater than the second distance.

22. The phase plug assembly of claim 21, wherein the occluding body comprises a bent exit delimited by the inner and outer vanes.

23. The phase plug of claim 6, wherein the occluding body is shaped symmetrically about the central axis of rotation.

24. The phase plug of claim 6, wherein the occluding body is shaped asymmetrically about the central axis of rotation.

25. The phase plug assembly of claim 19, wherein the occluding body comprises a circular receiving end disposed proximate to the acoustic entrance of the second section and a curved upper edge, formed by an intersection of the major planar surfaces, disposed at the acoustic exit of the second section, opposite from the circular receiving end.

26. The phase plug assembly of claim 8, wherein the entrance of the innermost and outermost passageways at the boundary face of the first section of the phase plug assembly are located to suppress the first order axial acoustic mode of the compression chamber.
